(19) United States
(12) Patent Application Publication
(10) Pub. No.: US 2026/0153658 A1
(43) Pub. Date: Jun. 4, 2026

(54) OPTICAL FILTER

(71) Applicant: AGC Inc., Tokyo (JP)

(72) Inventors: Takashi NAGATA, Shizuoka (JP); Takahiro SAKAGAMI, Shizuoka (JP); Kanako OHGUCHI, Shizuoka (JP); Kazuhiko SHIONO, Fukushima (JP); Kiyokazu ENDO, Fukushima (JP)

(73) Assignee: AGC Inc., Tokyo (JP)

(21) Appl. No.: 19/460,714

(22) Filed: Jan. 27, 2026

Related U.S. Application Data
(63) Continuation of application No. PCT/JP2024/029522, filed on Aug. 20, 2024.

(30) Foreign Application Priority Data
Aug. 23, 2023 (JP) 2023-135695

(51) Int. Cl. G02B 5/28

(52) U.S. Cl. CPC G02B 5/281; G02B 5/285

(57) ABSTRACT

An optical filter includes: a glass; a dielectric multilayer film 1 and a dielectric multilayer film 2; a barrier film 1; a barrier film 2; and a light-absorbing layer, in which the glass is a phosphate glass or a fluorophosphate glass, the light-absorbing layer includes a near-infrared ray absorbing dye, in a case where the glass is the phosphate glass, the barrier film 1 and the barrier film 2 each independently include one or more selected from TiO₂, Nb₂O₅, Ta₂O₅, and HfO₂, in a case where the glass is the fluorophosphate glass, the barrier film 1 and the barrier film 2 each independently include one or more selected from TiO₂, Al₂O₃, Nb₂O₅, Ta₂O₅, and HfO₂, and the optical filter satisfies all of spectral characteristics (i-1) to (i-3) and (i-6).

### CROSS-REFERENCE TO RELATED APPLICATIONS

This is a bypass continuation of International Patent Application No. PCT/JP2024/029522, filed on Aug. 20, 2024, which claims priority to Japanese Patent Application No. 2023-135695, filed on Aug. 23, 2023. The contents of these applications are hereby incorporated by reference in their entireties.

### TECHNICAL FIELD

The present invention relates to an optical filter that transmits visible light and shields near-infrared light.

### BACKGROUND ART

In an imaging device including a solid state image sensor, in order to satisfactorily reproduce a color tone and obtain a clear image, an optical filter that transmits light in a visible wavelength region (hereinafter, also referred to as “visible light”) and shields light in a near-infrared wavelength region (hereinafter, also referred to as “near-infrared light”) is used.

Examples of such an optical filter include various types such as a reflection type filter in which dielectric thin films having different refractive indices are alternately laminated on one surface or both surfaces of a transparent substrate (dielectric multilayer film) and light to be shielded is reflected by utilizing interference of light, an absorption type filter in which light to be shielded is absorbed by using a glass or a dye that absorbs light in a specific wavelength region, and a filter in which a reflection type filter and an absorption type filter are combined.

Here, a phosphate glass and a fluorophosphate glass are known as the glass that absorbs light, but is easily affected by moisture or the like in the environment. In particular, in the phosphate glass, phosphoric acid may be eluted to decompose other constituent materials of the optical filter. Therefore, a technique for preventing elution of phosphoric acid has been studied.

Patent Literature 1 discloses a phosphate glass having a protective film formed by coating a surface with alumina in order to improve moisture resistance.

Patent Literature 2 discloses an infrared cut filter in which a cover glass and an infrared ray absorbing glass such as a phosphate glass are bonded to each other via an adhesive in order to increase moisture resistance.

### CITATION LIST

### Patent Literature

Patent Literature 1: JPH04-139035A
Patent Literature 2: JP2016-18092A

### SUMMARY OF INVENTION

However, in the technique disclosed in Patent Literature 1, the surface of the phosphate glass covered with the alumina protective film is hardly affected by moisture, and the moisture resistance is improved, but a reaction between the moisture and an end surface of the glass not covered with the protective film cannot be prevented, and there is a concern that the phosphoric acid eluted from the end surface of the glass reacts with the alumina protective film to cause film peeling due to reduction in adhesion.

In the technique disclosed in Patent Literature 2, since the adhesive is an organic material, moisture is likely to penetrate from the vicinity of an end surface. Therefore, there is a concern that the adhesive is deteriorated by the phosphoric acid eluted from the glass and the adhesion is reduced.

In an optical filter including a dielectric multilayer film, since an optical film thickness of the dielectric multilayer film changes depending on an incident angle of light, there is a problem that a spectral transmittance curve changes depending on the incident angle. In particular, with the reduction in height of a camera module in recent years, use under a condition of a high incident angle is assumed, and therefore an optical filter that is less likely to be affected by an incident angle is required.

An object of the present invention is to provide an optical filter excellent in moisture resistance, and excellent in transmittance in a visible light region and shielding properties in a near-infrared region even at a high incident angle.

The present invention provides an optical filter having the following configuration.

An optical filter including: a glass:
a glass;
a dielectric multilayer film 1 and a dielectric multilayer film 2 provided on both surface sides of the glass;
a barrier film 1 provided between the glass and the dielectric multilayer film 1;
a barrier film 2 provided between the glass and the dielectric multilayer film 2; and
a light-absorbing layer provided on or above the dielectric multilayer film 2, in which
the glass is a phosphate glass having near-infrared ray absorbing properties and being substantially free from fluorine atoms, or a fluorophosphate glass having near-infrared ray absorbing properties and including a fluorine atom,
the light-absorbing layer includes a near-infrared ray absorbing dye having a maximum absorption wavelength at 680 nm to 800 nm, in a case where the glass is the phosphate glass, the barrier film 1 and the barrier film 2 each independently include one or more selected from TiO₂, Nb₂O₅, Ta₂O₅, and HfO₂, in a case where the glass is the fluorophosphate glass, the barrier film 1 and the barrier film 2 each independently include one or more selected from TiO₂, Al₂O₃, Nb₂O₅, Ta₂O₅, and HfO₂, and the optical filter satisfies all of the following spectral characteristics (i-1) to (i-3) and (i-6):
(i-1) an average transmittance at a wavelength of 440 nm to 500 nm is 80% or more at an incident angle of 0 degrees and 70% or more at an incident angle of 60 degrees,
(i-2) an average transmittance at a wavelength of 750 nm to 1,000 nm is 1% or less at an incident angle of 0 degrees and 1% or less at an incident angle of 60 degrees,
(i-3) in a spectral transmittance curve at an incident angle of 0 degrees, a wavelength IR10_{(0deg)} at which a transmittance is 10% is in a range of 600 nm to 700 nm, and
(i-6) when a light is incident from a dielectric multilayer film 1 side, a maximum reflectance at a wavelength of 850 nm to 1,200 nm is 85% or more at an incident angle of 5 degrees.

According to the present invention, an optical filter excellent in moisture resistance, and excellent in transmittance in a visible light region and shielding properties in a near-infrared region even at a high incident angle can be provided.

### BRIEF DESCRIPTION OF DRAWINGS

FIG. 1 is a cross-sectional view schematically illustrating an example of an optical filter according to one embodiment.

FIG. 2 is a cross-sectional view schematically illustrating another example of the optical filter according to one embodiment.

FIG. 3 is a diagram illustrating spectral transmittance curves of glasses 1, 3, and 4.

FIG. 4 is a diagram illustrating a spectral transmittance curve of a glass 2.

FIG. 5 is a diagram illustrating spectral transmittance curves of light-absorbing layers 1 and 2.

FIG. 6 is a diagram illustrating spectral transmittance curves and spectral reflectance curves of an optical filter of Example 2-1.

FIG. 7 is a diagram illustrating spectral transmittance curves and spectral reflectance curves of an optical filter of Example 2-3.

### DESCRIPTION OF EMBODIMENTS

Hereinafter, embodiments of the present invention will be described.

In the present description, a near-infrared ray absorbing dye may be abbreviated as an “NIR dye”, and an ultraviolet ray absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. A group represented by the formula (I) is also referred to as a group (I), and the same applies to groups represented by other formulae.

In the present description, spectra of a transmittance of a glass, a light-absorbing layer including a case where a dye is contained in a resin, a transmittance measured by dissolving a dye in a solvent such as dichloromethane, a transmittance of a dielectric multilayer film, and a transmittance of an optical filter having the dielectric multilayer film are all “external (measured) transmittance” including reflection losses of front and back surfaces even when described as “transmittance”.

In the present description, a transmittance of, for example, 90% or more in a specific wavelength region means that the transmittance does not fall below 90% in the entire wavelength region, that is, a minimum transmittance in the wavelength region is 90% or more. Similarly, a transmittance of, for example, 1% or less in a specific wavelength region means that the transmittance does not exceed 1% in the entire wavelength region, that is, a maximum transmittance is 1% or less in the wavelength region. An average transmittance in the specific wavelength region is an arithmetic mean of transmittance per 1 nm in the wavelength region.

Spectral characteristics can be measured by using an ultraviolet-visible spectrophotometer.

In the present description, the symbol “-” or the word “to” that is used to express a numerical range includes the numerical values before and after the symbol or the word as the upper limit and the lower limit of the range, respectively.

### <Optical Filter>

An optical filter according to one embodiment of the present invention (hereinafter, also referred to as “present filter”) includes a glass which is a phosphate glass or a fluorophosphate glass, a dielectric multilayer film 1 and a dielectric multilayer film 2 provided on both surface sides of the glass, and a light-absorbing layer provided on or above the dielectric multilayer film 2. The present filter further includes a barrier film 1 between the glass and the dielectric multilayer film 1, and a barrier film 2 between the glass and the dielectric multilayer film 2. The barrier films 1 and 2 contain a specific material as to be described later. Such barrier films prevent the glass from reacting with moisture in the environment, and an optical filter having excellent moisture resistance is obtained.

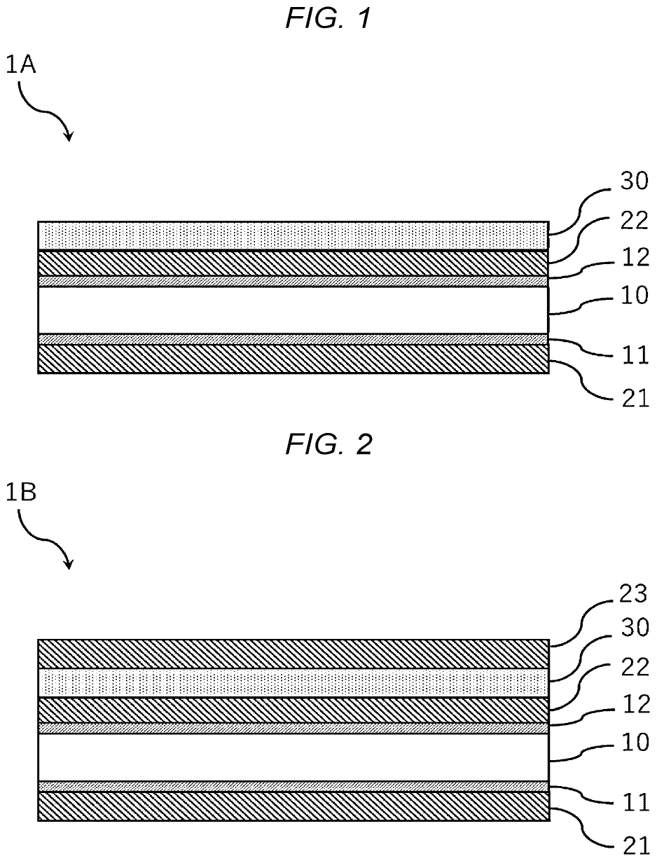

An example of a configuration of the present filter will be described with reference to the drawings. FIGS. 1 and 2 are cross-sectional views schematically illustrating examples of an optical filter according to one embodiment.

An optical filter 1A illustrated in FIG. 1 is an example including: a glass 10; a dielectric multilayer film 21 provided on one main surface side of the glass 10; a dielectric multilayer film 22 provided on the other main surface side of the glass 10; a light-absorbing layer 30 provided on the dielectric multilayer film 22; a barrier film 11 provided between the glass 10 and the dielectric multilayer film 21; and a barrier film 12 provided between the glass 10 and the dielectric multilayer film 22.

An optical filter 1B illustrated in FIG. 2 is an example further including a dielectric multilayer film 23 laminated on a surface of the light-absorbing layer 30.

The optical filter according to an embodiment of the present invention satisfies all of the following spectral characteristics (i-1) to (i-3) and (i-6).
(i-1) An average transmittance at a wavelength of 440 nm to 500 nm is 80% or more at an incident angle of 0 degrees and 70% or more at an incident angle of 60 degrees.
(i-2) An average transmittance at a wavelength of 750 nm to 1,000 nm is 1% or less at an incident angle of 0 degrees and 1% or less at an incident angle of 60 degrees.
(i-3) In a spectral transmittance curve at an incident angle of 0 degrees, a wavelength IR10_{(0deg)} at which a transmittance is 10% is in a range of 600 nm to 700 nm.
(i-6) When a light is incident from a dielectric multilayer film 1 side, a maximum reflectance at a wavelength of 850 nm to 1,200 nm is 85% or more at an incident angle of 5 degrees.

The present filter satisfying all of the spectral characteristics (i-1) to (i-3) and (i-6) is an optical filter excellent in transmittance of visible light as shown in the characteristic (i-1) and excellent in shielding properties of near-infrared light at a wavelength of 750 nm to 1,000 nm as shown in the characteristic (i-2).

The optical filter according to an embodiment of the present invention preferably satisfies the following spectral characteristics (i-4) and (i-5).
(i-4) An absolute value of a difference between the wavelength IR10_{(0deg)} at which the transmittance is 10% in the range of 600 nm to 700 nm in the spectral transmittance curve at an incident angle of 0 degrees and a wavelength IR10 (60deg) at which a transmittance is 10% in the range of 600 nm to 700 nm in a spectral transmittance curve at an incident angle of 60 degrees is 20 nm or less.
(i-5) A transmittance at a wavelength of 1,100 nm is 1% or less at an incident angle of 0 degrees and 3% or less at an incident angle of 60 degrees.

The present filter satisfying the spectral characteristics (i-4) and (i-5) is an optical filter excellent in shielding properties of near-infrared light at a wavelength of 1,100 nm as shown in the characteristic (i-5) and having a transmittance less likely to shift even at a high incident angle as shown in the characteristic (i-4).

Satisfying the spectral characteristic (i-1) means that a transmittance in a visible light region of 440 nm to 500 nm is excellent even at a high incident angle.

The average transmittance at a wavelength of 440 nm to 500 nm is preferably 81% or more, more preferably 82% or more at an incident angle of 0 degrees, and is preferably 71% or more, more preferably 72% or more at an incident angle of 60 degrees.

In addition, in order to satisfy the spectral characteristic (i-1), for example, a dielectric multilayer film, a glass, or a near-infrared light absorbing dye having an excellent transmittance in the visible light region may be used.

Satisfying the spectral characteristic (i-2) means that the shielding properties in a near-infrared region of 750 nm to 1,000 nm are excellent even at a high incident angle.

The average transmittance at a wavelength of 750 nm to 1,000 nm is preferably 0.5% or less, more preferably 0.2% or less at an incident angle of 0 degrees, and is preferably 0.5% or less, more preferably 0.2% or less at an incident angle of 60 degrees.

In addition, in order to satisfy the spectral characteristic (i-2), for example, light may be shielded by an absorption ability of the glass and the near-infrared light absorbing dye.

Satisfying the spectral characteristic (i-3) means that a wavelength region of 600 nm to 700 nm is a region in which a spectral transmittance curve rises from a near-infrared shielding region to a visible light transmission region.

The wavelength IR10_{(0deg)} is preferably in a range of 620 nm to 700 nm, and more preferably in a range of 650 nm to 700 nm.

Satisfying the spectral characteristic (i-4) means that the spectral transmittance curve is less likely to shift in a wavelength region of 600 nm to 700 nm even at a high incident angle.

The absolute value of the difference between the wavelength IR10_{(0deg)} and the wavelength IR10_{(60deg)} is preferably 15 nm or less, and more preferably 13 nm or less.

In addition, in order to satisfy the spectral characteristic (i-4), for example, light in the wavelength region of 600 nm to 700 nm may be shielded by an absorption ability of the glass and the near-infrared light absorbing dye that are not affected by the incident angle.

Satisfying the spectral characteristic (i-5) means that the shielding properties in a near-infrared region of 1,100 nm are excellent even at a high incident angle.

The transmittance at a wavelength of 1,100 nm is preferably 0.5% or less, more preferably 0.2% or less at an incident angle of 0 degrees, and is preferably 2% or less, more preferably 1% or less at an incident angle of 60 degrees.

In addition, in order to satisfy the spectral characteristic (i-5), for example, light may be shielded by an absorption ability of the glass.

Satisfying the spectral characteristic (i-6) means that light-shielding properties in a range of 850 nm to 1,200 nm are ensured by reflection characteristics of the dielectric multilayer film 1.

The maximum reflectance at a wavelength of 850 nm to 1,200 nm is preferably 90% or more, and more preferably 95% or more.

The optical filter according to the present embodiment preferably satisfies the following spectral characteristics (i-7) and (i-8).
(i-7) When a light is incident from a light-absorbing layer side, a maximum reflectance at a wavelength of 450 nm to 750 nm is 20% or less at an incident angle of 60 degrees.
(i-8) When a light is incident from the light-absorbing layer side, a maximum reflectance at a wavelength of 750 nm to 1,200 nm is 42% or less at an incident angle of 60 degrees.

Satisfying the spectral characteristics (i-7) and (i-8) means that the dielectric multilayer film 2 has low reflection characteristics even at a high incident angle in a region from visible light to near-infrared light at a wavelength of 450 nm to 1,200 nm. Even when the multilayer film 2 has low reflection characteristics of near-infrared light, the light is absorbed by the glass or the near-infrared light absorbing dye and reflected by the multilayer film 1, and thus the light-shielding properties of the optical filter as a whole can be sufficiently ensured.

The maximum reflectance at a wavelength of 450 nm to 750 nm is more preferably 19.8% or less, and further preferably 19.5% or less.

The maximum reflectance at a wavelength of 750 nm to 1,200 nm is more preferably 41.5% or less, and further preferably 41.0% or less.

The spectral characteristics (i-7) and (i-8) can be achieved by using, for example, the dielectric multilayer film 2 and the barrier film 2 in which X to be described later is in a specific range.

The optical filter according to the present embodiment preferably satisfies the following spectral characteristic (i-9).
(i-9) When a light is incident from a light-absorbing layer side, a maximum reflectance at a wavelength of 450 nm to 750 nm is 7.5% or less at an incident angle of 5 degrees.

Satisfying the spectral characteristic (i-9) means that the dielectric multilayer film 2 has low reflection characteristics in a region from visible light to near-infrared light at a wavelength of 450 nm to 750 nm.

The maximum reflectance at a wavelength of 450 nm to 750 nm is more preferably 7.4% or less, and further preferably 7.3% or less.

The spectral characteristic (i-9) can be achieved by using, for example, the dielectric multilayer film 2 and the barrier film 2 in which X to be described later is in a specific range.

The optical filter according to the present embodiment preferably satisfies the following spectral characteristic (i-10).
(i-10) When a light is incident from the dielectric multilayer film 1 side, an average reflectance at a wavelength of 800 nm to 1,100 nm is 95% or more at an incident angle of 5 degrees.

Satisfying the spectral characteristic (i-10) means that the dielectric multilayer film 1 has wide reflection characteristics in a near-infrared region of a wavelength of 800 nm to 1,100 nm.

The average reflectance at a wavelength of 800 nm to 1,100 nm is more preferably 96% or more, and further preferably 97% or more.

### <Glass>

The optical filter according to the present embodiment includes the phosphate glass or the fluorophosphate glass. The phosphate glass or the fluorophosphate glass has near-infrared ray absorbing properties and also functions as a support for the optical filter. In addition, since light is shielded by the absorbing properties, light-shielding properties are less likely to be affected by the incident angle unlike the dielectric multilayer film.

The glass preferably has, in terms of a plate thickness of 0.2 mm, a transmittance of 80% or more at a wavelength of 420 nm, a transmittance of 6% or less at a wavelength of 800 nm, and a transmittance of 25% or less at a wavelength of 1,200 nm. A glass satisfying such spectral characteristics is preferable because it has a sufficient transmittance of visible light and excellent near-infrared light absorption ability.

In the present description, the phosphate glass means a glass containing 40% or more of P₂O₅ in terms of mol % based on oxides and being substantially free from fluorine atoms. Here, the expression of “being substantially free from fluorine atoms” means that when a content of a component element other than F contained in the glass is defined as 100 mass %, and a content of F contained in the glass is indicated in terms of outer percentage, the content of F is less than 3 mass % in terms of outer percentage.

In the present description, the fluorophosphate glass refers to a glass containing 20% or more of P⁵⁺in terms of mass % and 3% or more of F⁻in terms of outer percentage.

Preferably, the phosphate glass is substantially free from fluorine atoms, and includes, in terms of mol % based on oxides,
40% to 75% of P₂O₅,
10% to 30% of Al₂O₃,
0.1% to 30% of ΣR₂O where R₂O is one or more components selected from Li₂O, Na₂O, K₂O, Rb₂O, and Cs₂O, and ΣR₂₀ is a total content of R₂O,
0% to 30% of ΣR′O where R′O is one or more components selected from CaO, MgO, BaO, SrO, and ZnO, and ER′O is a total content of R′O, and
2% to 30% of CuO.

The fluorophosphate glass preferably contains, in terms of mass %,
20% to 70% of P⁵⁺,
1% to 20% of Al⁺,
0% to 30% of Li⁺,
0% to 40% of Na⁺,
0% to 40% of K⁺,
0% to 20% of Rb⁺,
0% to 20% of Cs⁺,
0% to 20% of Mg²⁺,
0% to 20% of Ca²⁺,
0% to 30% of Sr²⁺,,
0% to 45% of Ba²⁺,
1% to 55% of ΣR⁺(R⁺is one or more components selected from Li⁺, Na⁺, K⁺, Rb⁺, and Cs⁺),
1% to 50% of ΣR′²⁺(R′²⁺is one or more components selected from Mg²⁺, Ca²⁺, Sr²⁺, and Ba²⁺),
1% to 20% of Cu²⁺, and
0% to 20% of Zn²⁺, and
the fluorophosphate glass preferably contains, in terms of outer percentage, 3 mass % to 60 mass % of F⁻ when a content of a component element other than F⁻ contained in the glass is set to 100 mass %.

Each component that can form the phosphate glass and a suitable content thereof are described below. In the following description related to the phosphate glass, unless otherwise specified, a content of each component and a total content are expressed in terms of mol % based on oxides.

P₂O₅ is a main component forming the glass, and is a component for enhancing a near-infrared ray cutting property. When a content of P₂O₅ is 40% or more, an effect thereof can be sufficiently obtained, and when the content of P₂O₅ is 75% or less, problems such as glass instability and reduction in weather resistance are less likely to occur. Therefore, the content of P₂O₅ is preferably 45% to 75%, more preferably 50% to 70%, further preferably 52% to 65%, still further preferably 54% to 65%, and most preferably 55% to 60%.

Al₂O₃ is a main component forming the glass, and is a component for enhancing the strength of the glass, enhancing the weather resistance of the glass, and the like. When the content of Al₂O₃ is 10% or more, an effect thereof can be sufficiently obtained, and when the content of Al₂O₃ is 30% or less, problems such as glass instability and reduction in near-infrared ray cutting property are less likely to occur. Therefore, the content of Al₂O₃ is preferably 10% to 30%, more preferably 11% to 27%, further preferably 12% to 26%, still further preferably 12.5% to 25%, and most preferably 13% to 24%. When the content of Al₂O₃ is 13% or more, the weather resistance of the glass can be particularly enhanced.

R₂O (where R₂O is one or more components selected from Li₂O, Na₂O, K₂O, Rb₂O, and Cs₂O) is a component for lowering a melting temperature of the glass, lowering a liquid phase temperature of the glass, stabilizing the glass, and the like. When a total content of R₂O (ΣR₂O) is 0.1% or more, an effect thereof can be sufficiently obtained, and when the total content of R₂O is 30% or less, glass instability is less likely to occur, which is preferable. Therefore, the total content of R₂O is preferably 1% to 25%, more preferably 2% to 20%, further preferably 3% to 18%, still further preferably 4% to 17%, and most preferably 5% to 18%.

Li₂O is a component for lowering the melting temperature of the glass, lowering the liquid phase temperature of the glass, stabilizing the glass, and the like. A content of Li₂O is preferably 0% to 20%. When the content of Li₂O is 20% or less, problems such as glass instability and reduction in near-infrared ray cutting property are less likely to occur, which is preferable. The content of Li₂O is more preferably 0% to 15%, further preferably 0% to 10%, and still further preferably 0% to 5%. Most preferably, Li₂O is not substantially contained.

In the present invention, the expression of “a specific component is not substantially contained” means that the component is not intentionally added, and does not exclude inclusion of the component to the extent that the component is unavoidably mixed in from raw materials, or the like, and does not affect desired properties.

Na₂O is a component for lowering the melting temperature of the glass, lowering the liquid phase temperature of the glass, stabilizing the glass, and the like. A content of Na₂O is preferably 0% to 25%. When the content of Na₂O is 25% or less, glass instability is less likely to occur, which is preferable. The content of Na₂O is more preferably 0.5% to 20%, further preferably 1% to 15%, and still further preferably 2% to 10%.

K₂O is a component having effects such as lowering the melting temperature of the glass and lowering the liquid phase temperature of the glass. A content of K₂O is preferably 0% to 25%. When the content of K₂O is 25% or less, glass instability is less likely to occur, which is preferable. The content of K₂O is more preferably 0.5% to 20%, further preferably 1% to 15%, and still further preferably 2% to 13%.

Rb₂O is a component having effects such as lowering the melting temperature of the glass and lowering the liquid phase temperature of the glass. A content of Rb₂O is preferably 0% to 25%. When the content of Rb₂O is 25% or less, glass instability is less likely to occur, which is preferable. The content of Rb₂O is more preferably 0.5% to 20%, further preferably 1% to 15%, and still further preferably 2% to 10%.

Cs₂O is a component having effects such as lowering the melting temperature of the glass and lowering the liquid phase temperature of the glass. A content of Cs₂O is preferably 0% to 25%. When the content of Cs₂O is 25% or less, glass instability is less likely to occur, which is preferable. The content of Cs₂O is more preferably 0.5% to 20%, further preferably 1% to 15%, and still further preferably 2% to 10%.

When two or more of the above alkali metal components represented by R₂O are added at the same time, a mixed alkali effect is generated in the glass, and a mobility of R′ions is reduced. Accordingly, when the glass comes into contact with water, a hydration reaction caused by ion exchange between H′ ions in water molecules and the R′ ions in the glass is inhibited, and the weather resistance of the glass is improved. Therefore, the glass of the present embodiment preferably contains two or more components selected from Li₂O, Na₂O, K₂O, Rb₂O, and Cs₂O. In this case, the total content of R₂O (ΣR₂O) (where R₂O is two or more components selected from Li₂O, Na₂O. K₂O, Rb₂O, and Cs₂O) is preferably 6% to 18% (where 7% is excluded). When the total content of R₂O is 6% or more, an effect thereof can be sufficiently obtained, and when the total content of R₂O is 18% or less, problems such as glass instability, reduction in near-infrared ray cutting property, and reduction in strength of the glass are less likely to occur, which is preferable. Therefore, ΣR₂₀ is preferably 7% to 18%, more preferably 8% to 18%, further preferably 9% to 18%, still further preferably 10% to 18%, and most preferably 10.5% to 18%.

R′O (where R′O is one or more components selected from CaO, MgO, BaO, SrO, and ZnO) is a component for lowering the melting temperature of the glass, lowering the liquid phase temperature of the glass, stabilizing the glass, enhancing the strength of the glass, and the like. A total content of R′O (ΣR′O) is preferably 0% to 30%. When the total content of R′O is 30% or less, problems such as glass instability, reduction in near-infrared ray cutting property, reduction in transmittance of short wavelength infrared rays, and reduction in strength of the glass are less likely to occur, which is preferable. The total content of R′O is more preferably 0% to 25%, and further preferably 0% to 20%. The total content of R′O is still further preferably 0% to 15%, and still further preferably 0% to 10%.

The phosphate glass of the present embodiment preferably contains substantially no divalent cation other than Cu. The reason for this will be described below.

In a case where the phosphate glass of the present embodiment contains CuO, light in a near-infrared ray region is cut by light absorption of Cu²⁺ions. The light absorption is caused by electron transition between d-orbits of Cu²⁺ions split by an electric field of O²⁻ ions. The splitting of d-orbits is promoted when symmetry of the O²⁻ ions existing around the Cu²⁺ions is reduced. For example, when cations exist around the O²⁻ ions, the O²⁻ ions are attracted by an electric field of the cations, and the symmetry of the O²⁻ ions is reduced. As a result, the splitting of d-orbits is promoted, and the light absorption occurs due to the electron transition between the split d-orbits, and thus a light absorption ability in the near-infrared region is weakened, and a light absorption ability in a short wavelength infrared region is strengthened. Since the strength of the electric field of the cations becomes stronger when the valence of ions is large, in particular, when an oxide containing divalent cations other than Cu is added to the glass, there is a concern that the near-infrared ray cutting property is reduced and a transmittance of the short wavelength infrared rays is reduced.

CaO is a component for lowering the melting temperature of the glass, lowering the liquid phase temperature of the glass, stabilizing the glass, enhancing the strength of the glass, and the like. A content of CaO is preferably 0% to 20%. When the content of CaO is 20% or less, problems such as glass instability, reduction in near-infrared ray cutting property, and reduction in transmittance of short wavelength infrared rays are less likely to occur, which is preferable. The content of CaO is more preferably 0% to 15%, further preferably 0% to 10%, and still further preferably 0% to 5%. Most preferably, CaO is not substantially contained.

MgO is a component for lowering the melting temperature of the glass, lowering the liquid phase temperature of the glass, stabilizing the glass, enhancing the strength of the glass, and the like. A content of MgO is preferably 0% to 20%. When the content of MgO is 20% or less, problems such as glass instability, reduction in near-infrared ray cutting property, and reduction in transmittance of short wavelength infrared rays are less likely to occur, which is preferable. The content of MgO is more preferably 0% to 15%, further preferably 0% to 10%, and still further preferably 0% to 5%. Most preferably, MgO is not substantially contained.

BaO is a component for lowering the melting temperature of the glass, lowering the liquid phase temperature of the glass, stabilizing the glass, and the like. A content of BaO is preferably 0% to 20%. When the content of BaO is 20% or less, problems such as glass instability, reduction in near-infrared ray cutting property, and reduction in transmittance of short wavelength infrared rays are less likely to occur, which is preferable. The content of BaO is more preferably 0% to 15%, further preferably 0% to 10%, and still further preferably 0% to 5%. The content of BaO may be 0.1% or more. Most preferably, BaO is not substantially contained.

SrO is a component for lowering the melting temperature of the glass, lowering the liquid phase temperature of the glass, stabilizing the glass, and the like. A content of SrO is preferably 0% to 20%. When the content of SrO is 20% or less, problems such as glass instability, reduction in near-infrared ray cutting property, and reduction in transmittance of short wavelength infrared rays are less likely to occur, which is preferable. The content of SrO is more preferably 0% to 15%, and further preferably 0% to 10%. Most preferably, SrO is not substantially contained.

ZnO has effects such as lowering the melting temperature of the glass and lowering the liquid phase temperature of the glass. A content of ZnO is preferably 0% to 20%. When the content of ZnO is 20% or less, problems such as deterioration of the solubility of the glass, reduction in near-infrared ray cutting property, and reduction in transmittance of short wavelength infrared rays are less likely to occur, which is preferable. The content of ZnO is more preferably 0% to 15%, further preferably 0% to 10%, and still further preferably 0% to 5%. Most preferably, ZnO is not substantially contained.

CuO is a component for cutting near-infrared rays. A content of CuO is preferably 2% to 30%. When the content of CuO is 2% or more, an effect thereof can be sufficiently obtained, and when the content of CuO is 30% or less, problems such as reduction in transmittance in the visible light region and reduction in transmittance in the short wavelength infrared region are less likely to occur, which is preferable. The content of CuO is more preferably 5% to 25%, further preferably 8% to 20%, and still further preferably 11% to 18%. The content of CuO is yet still further preferably 12% or more. In particular, in a case where the glass contains substantially no divalent cation other than Cu, when the content of CuO is 12% or more, the cutting property of the near-infrared ray and the transmittance of the short wavelength infrared ray can be further enhanced. The content of CuO is most preferably 13% to 18%.

B₂O₃ may be contained in a range of 15% or less for stabilizing the glass. When the content of B₂O₃ is 15% or less, problems such as deterioration of weather resistance of the glass, reduction in near-infrared ray cutting property, and reduction in transmittance of short wavelength infrared rays are less likely to occur, which is preferable. The content of B₂O₃ is preferably 13% or less, more preferably 11% or less, further preferably 9% or less, and still further preferably 7% or less. Most preferably, B₂O₃ is not substantially contained.

MoO₃ is a component for increasing the transmittance of light in the visible region of the glass. When a content of MoO₃ is 0.1% or more, the effect of increasing the transmittance of light in the visible region of the glass can be sufficiently obtained, and when the content of MoO₃ is 5% or less, problems such as reduction in near-infrared ray cutting property and generation of devitrification foreign matters in the glass are less likely to occur, which is preferable. The content of MoO₃ is more preferably 0.1% to 4.5%, further preferably 0.1% to 4%, still further preferably 0.1% to 3.5%, and most preferably 0.1% to 3%.

In the phosphate glass of the present embodiment, F (fluorine atom) is an effective component for increasing the weather resistance, but F is an environmental load substance and there is a concern that the near-infrared ray cutting property may be reduced, and thus the glass is substantially free from fluorine atoms. The expression of “the glass is substantially free from fluorine atoms” means that when a content of a component element other than F contained in the glass is defined as 100 mass %, and a content of F contained in the glass is indicated in terms of outer percentage, the content of F is less than 3 mass % in terms of outer percentage.

In the phosphate glass of the present embodiment, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 5% or less in order to improve the weather resistance of the glass. When the content of these components is 5% or less, problems such as reduction in near-infrared ray cutting property, and reduction in transmittance of short wavelength infrared rays are less likely to occur, which is preferable. The content of these components is preferably 4% or less, more preferably 3% or less, further preferably 2% or less, and still further preferably 1% or less.

Next, each component that can form the fluorophosphate glass and a suitable content thereof is described below. In the following description related to the fluorophosphate glass, unless otherwise specified, a content of each component and a total content are expressed in terms of mass %.

In the fluorophosphate glass, P (phosphorus) is contained as PS⁵⁺. P⁵⁺is a main component forming the fluorophosphate glass, and is an essential component for improving the sharp cutting property in the near-infrared region. A content of P⁵⁺is preferably 20% to 70%.

When the content of P⁵⁺is 20% or more, the effect thereof can be sufficiently obtained, and when the content of P⁵⁺is 70% or less, problems such as glass instability and reduction in weather resistance are less likely to occur. Therefore, the content of P⁵⁺is more preferably 25% or more, further preferably 30% or more, still further preferably 33% or more, and most preferably 35% or more, and is more preferably 60% or less, further preferably 55% or less, still further preferably 50% or less, and most preferably 45% or less. As a raw material for P⁵⁺, it is preferable to use phosphoric acid or phosphate from the viewpoint of preventing corrosion of a platinum crucible and preventing volatilization of the component.

In the fluorophosphate glass, F (fluorine) is contained as F⁻. F⁻ is an essential component for stabilizing the glass and improving the weather resistance. In the present description, the content of F⁻contained in the glass is expressed in terms of outer percentage when component elements other than F⁻contained in the glass are defined as 100 mass %. The content of F⁻ is preferably 3% to 60% in terms of outer percentage.

When the content of F is 3% or more in terms of outer percentage, an effect of the weather resistance is sufficiently obtained, and when the content of F⁻ is 60% or less in terms of outer percentage, problems such as reduction in transmittance of light in a visible region, and absorption ability and sharp cutting property of light in the near-infrared region, reduction in mechanical properties such as strength, hardness, and elastic modulus, and an increase in transmittance of ultraviolet rays are less likely to occur. The content of F⁻ is more preferably 4% or more in terms of outer percentage, further preferably 6% or more in terms of outer percentage, still further preferably 8% or more in terms of outer percentage, and most preferably 10% or more in terms of outer percentage, and is more preferably 50% or less in terms of outer percentage, further preferably 40% or less in terms of outer percentage, still further preferably 30% or less in terms of outer percentage, and most preferably 20% or less in terms of outer percentage

In the fluorophosphate glass, Cu (copper) is contained as Cu⁺ or Cu²⁺, but in the present description, the content is described as when all Cu existed as Cu²⁺Cu²⁺is a component for improving the absorption ability in the near-infrared region.

Since Cu²⁺has a characteristic of forming a crosslinked structure by attracting phosphate chains in the glass, the glass structure is strengthened, and the weather resistance and the strength of the glass are improved. A content of Cu²⁺ is preferably 1% to 20%. When the content of Cu²⁺is less than 1%, the absorption ability of the glass in the near-infrared region may be reduced. The content of Cu²⁺ is preferably 2% or more, more preferably 3% or more, further preferably 4% or more, and still further preferably 5% or more. When the content of Cu²⁺ is more than 20%, the glass becomes unstable, and a risk of devitrification is increased. The content of Cu²⁺is preferably 18% or less, more preferably 14% or less, further preferably 12% or less, and still further preferably 10% or less.

A total amount of Cu is a total amount of Cu in terms of mass %, including those of monovalent, divalent, and other existing valences, and in a case where the content of all components in the fluorophosphate glass (excluding content of F⁻) is defined as 100%, a range of a content of the total amount of Cu in the glass is preferably 1% to 20%. When the total amount of Cu is 1% or more, an effect of the absorption ability in the near-infrared region can be sufficiently obtained, and when the total amount of Cu is 20% or less, reduction in transmittance of the visible region can be prevented. A content of Cu′ expressed in terms of % can be determined such that (Cu⁺/total amount of Cu)×100 [%] is in a range of 0.01% to 4.0%.

In the fluorophosphate glass, Al(aluminum) is contained as Al₃⁺. Al₃⁺is a component forming the glass, and is a component for enhancing the strength of the glass, enhancing the weather resistance of the glass, and the like. When a content of Al₃⁺′ is 1% or more, an effect thereof is sufficiently obtained, and when the content of Al₃⁺is 20% or less, problems such as glass instability and reduction in absorption ability and sharp cutting property in the near-infrared region are less likely to occur. The content of Al₃⁺is preferably 1% to 20%. The content of Al₃⁺is more preferably 2% or more, further preferably 3% or more, still further preferably 4% or more, and most preferably 5% or more, and is more preferably 19% or less, further preferably 18% or less, still further preferably 15% or less, and most preferably 13% or less.

As a raw material for Al₃⁺, AlF₃, Al₂O₃, Al(OH)₃, and the like can be used. Among them, it is preferable to use AlF₃, since problems such as an increase in melting temperature, generation of unmelted matter, and glass instability due to reduction in charged amount of F⁻ are less likely to occur.

Li (lithium) is a component for lowering the melting temperature of the glass, lowering a liquid phase temperature of the glass, improving the weather resistance of the glass, stabilizing the glass, and the like. A content of Li⁺is preferably 0% to 30%. When the content of Li⁺is 30% or less, the glass is less likely to become unstable. Since the absorption ability and sharp cutting property in the near-infrared region are reduced when Li is contained, the content of Li⁺ is more preferably 28% or less, further preferably 25% or less, still further preferably 20% or less, and most preferably 10% or less. The content of Li is more preferably 0.5% or more, further preferably 1% or more, and still further preferably 3% or more. When the alkali metal component is only Li⁺, the weather resistance is improved, but the absorption ability and sharp cutting property in the near-infrared region are reduced, and therefore, it is necessary to further contain one or more alkali metal components having an ionic radius larger than that of Li⁺.

Na (sodium) is a component for lowering the melting temperature of the glass. lowering the liquid phase temperature of the glass, stabilizing the glass, and the like. A content of Na⁺is preferably 0% to 40%. When the content of Na⁺is 40% or less, the glass is less likely to become unstable. The content of Na⁺is more preferably 30% or less, further preferably 25% or less, still further preferably 20% or less, and most preferably 10% or less. The content of Na⁺ is more preferably 0.5% or more, further preferably 1% or more, and still further preferably 3% or more. When the alkali metal component is only Na⁺, one of effects of improving the weather resistance and improving the high absorption ability and sharp cutting property in the near-infrared region is obtained, and characteristics improved are different depending on a composition system. However, it is difficult to improve both characteristics at the same time. Therefore, it is necessary to contain one or more types of alkali metal components other than Na⁺in order to improve the weather resistance, and to contain an alkali metal component having an ionic radius larger than that of Na⁺in order to improve the absorption ability and sharp cutting property in the near-infrared region.

In the fluorophosphate glass, K (kalium) is contained as K⁺. K⁺ is a component having effects such as lowering the melting temperature of the glass, lowering the liquid phase temperature of the glass, and improving the absorption ability and sharp cutting property in the near-infrared region. A content of K⁺ is preferably 0% to 40%. When the content of K⁺ is 40% or less, the glass is less likely to become unstable, which is preferable. The content of K⁺ is more preferably 0.5% or more, further preferably 1% or more, still further preferably 3% or more, and most preferably 5% or more, and since the weather resistance is reduced when K is contained, the content of K is preferably 30% or less, further preferably 25% or less, still further preferably 20% or less, and most preferably 14% or less. When the alkali metal component is only K⁺, the absorption ability and sharp cutting property in the near-infrared region are improved, but the weather resistance is reduced. Therefore, in order to improve the weather resistance by an alkali mixing effect, it is necessary to contain one or more types of alkali metal components other than K⁺.

Rb (rubidium) is a component having effects such as lowering the melting temperature of the glass, lowering the liquid phase temperature of the glass, and improving the absorption ability and sharp cutting property in the near-infrared region. A content of Rb⁺ is preferably 0% to 20%. When the content of Rb is 20% or less, the glass is less likely to become unstable, which is preferable. Since the weather resistance is reduced when Rb is contained, the content of Rb is more preferably 15% or less, further preferably 10% or less, and still further preferably 5% or less. The content of Rb⁺ is more preferably 0.5% or more, further preferably 1% or more, and still further preferably 3% or more. When the alkali metal component is only Rb, the absorption ability and sharp cutting property in the near-infrared region are improved, but the weather resistance is reduced. Therefore, in order to improve the weather resistance by an alkali mixing effect, it is necessary to contain one or more types of alkali metal components other than Rb.

Cs (cesium) is a component having effects such as lowering the melting temperature of the glass, lowering the liquid phase temperature of the glass, and improving the high absorption ability and sharp cutting property in the near-infrared region. A content of Cs⁺is preferably 0% to 20%. When the content of Cs is 20% or less, the glass is less likely to become unstable, which is preferable. Since the weather resistance is reduced when Cs' is contained, the content of Cs⁺is more preferably 15% or less, further preferably 10% or less, and still further preferably 5% or less. The content of Cs⁺ is more preferably 0.5% or more, further preferably 1% or more, and still further preferably 3% or more. When the alkali metal component is only Cs⁺, the absorption ability and sharp cutting property in the near-infrared region are improved, but the weather resistance is reduced. Therefore, in order to improve the weather resistance by an alkali mixing effect, it is necessary to contain one or more types of alkali metal components other than Cs⁺.

R⁺ (R⁺ is one or more selected from Li⁺, Na⁺, K⁺, Rb⁺, and Cs⁺) is a component for lowering the melting temperature of the glass, lowering the liquid phase temperature of the glass, stabilizing the glass, and the like. When a total amount of R′, that is, a total amount (ΣR) of Li⁺, Na⁺, K⁺, Rb⁺, and Cs⁺is 1% or more, an effect thereof is sufficiently obtained, and when the total amount of R⁺ is 55% or less, the glass is less likely to become unstable, which is preferable. Therefore, the content of ΣR⁺is preferably 1% to 55%. The content of ΣR⁺ is more preferably 5% or more, further preferably 10% or more, still further preferably 12% or more, and most preferably 15% or more, and is more preferably 45% or less, further preferably 40% or less, still further preferably 30% or less, and most preferably 28% or less.

Mg (magnesium) is a component for lowering the melting temperature of the glass, lowering the liquid phase temperature of the glass, stabilizing the glass, enhancing the strength of the glass, enhancing the weather resistance of the glass, and the like. A content of Mg²⁺is preferably 0% to 20%. When the content of Mg²⁺ is 20% or less, problems such as glass instability and reduction in near-infrared ray cutting property are less likely to occur. The content of Mg²⁺ is more preferably 15% or less, further preferably 10% or less, and still further preferably 5% or less.

Ca (calcium) is a component for lowering the melting temperature of the glass, lowering the liquid phase temperature of the glass, stabilizing the glass, enhancing the strength of the glass, enhancing the weather resistance of the glass, and the like. A content of Ca²⁺is preferably 0% to 20%. When the content of Ca²⁺is 20% or less, problems such as glass instability and reduction in near-infrared ray cutting property are less likely to occur. The content of Ca²⁺is more preferably 1% or more, further preferably 2% or more, and is more preferably 18% or less, further preferably 15% or less, still further preferably 10% or less, and most preferably 7% or less.

Sr (strontium) is a component for lowering the melting temperature of the glass, lowering the liquid phase temperature of the glass, stabilizing the glass, enhancing the strength of the glass, enhancing the weather resistance of the glass, and the like. A content of Sr²⁺ is preferably 0% to 30%. When the content of Sr²⁺ is 30% or less, problems such as glass instability and reduction in near-infrared ray cutting property are less likely to occur. The content of Sr²⁺ is more preferably 1% or more, further preferably 2% or more, still further preferably 4% or more, and most preferably 5% or more, and is more preferably 25% or less, further preferably 20% or less, still further preferably 16% or less, and most preferably 14% or less.

Ba (barium) is a component for lowering the melting temperature of the glass, lowering the liquid phase temperature of the glass, stabilizing the glass, enhancing the absorption ability of light in the near-infrared region, enhancing the sharp cutting property in the near-infrared region, and the like. A content of Ba²⁺is preferably 0% to 40%. When the content of Ba²⁺is 40% or less, problems such as glass instability are less likely to occur. The content of Ba²⁺ is more preferably 1% or more, further preferably 5% or more, and still further preferably 10% or more, and is more preferably 35% or less, further preferably 30% or less, and still further preferably 20% or less.

R²⁺(R²⁺ is one or more components selected from Mg²⁺, Ca²⁺, Sr²⁺, and Ba²⁺) is a component for lowering the melting temperature of the glass, lowering the liquid phase temperature of the glass, stabilizing the glass, and the like. When a total content of R₂t, that is, a total content (ΣR²⁺) of Mg²⁺, Ca²⁺, Sr²⁺, and Ba²⁺, is 1% or more, the effect thereof is sufficiently obtained, and when the total content of R²⁺is 50% or less, the glass is unlikely to become unstable. Therefore, the content of ΣR²⁺is preferably 1% to 50%. The content of ΣR²⁺is more preferably 5% or more, further preferably 10% or more, still further preferably 15% or more, and most preferably 20% or more, and is more preferably 45% or less, further preferably 40% or less, still further preferably 35% or less, and most preferably 32% or less.

Zn (zinc) has effects such as lowering the melting temperature of the glass and lowering the liquid phase temperature of the glass. A content of Zn²⁺is preferably 0% to 20%. When the content of Zn²⁺ is 20% or less, problems such as glass instability, reduction in solubility of the glass, and reduction in near-infrared ray cutting property are less likely to occur. The content of Zn²⁺ is more preferably 15% or less, further preferably 10% or less, and still further preferably 5% or less.

(Content of P⁵⁺)/ΣR″ (R″ is one or more components selected from Al₃⁺;, Mg²⁺, and Li⁺, and ΣR″ is a total amount of R″) is preferably 3.0 to 7.5.

P⁵⁺is a component for enhancing the sharp cutting property in the near-infrared region, but also has an effect of reducing the weather resistance. Al₃⁺t, Li⁺, and Mg′ are each a component having an effect of improving the weather resistance.

Therefore, when a ratio of the content of P⁵⁺ to ΣR″ is 7.5 or less, the weather resistance of the glass can be improved. When the ratio of the content of P⁵⁺ to ΣR″ is 3.0 or more, the sharp cutting property of the glass in the near-infrared region can be maintained high. The content ratio of P⁵⁺to ΣR″ is more preferably 3.5 or more, further preferably 4.0 or more, and still further preferably 4.5 or more, and is more preferably 7.0 or less, further preferably 6.5 or less, still further preferably 6.0 or less, and most preferably 5.5 or less.

B (boron) may be contained in a range of 20% or less in order to stabilize the glass. When a content of B³⁺ is 20% or less, problems such as deterioration in weather resistance of the glass and deterioration in near-infrared ray cutting property are less likely to occur. The content of B³⁺ is more preferably 15% or less, further preferably 10% or less, still further preferably 8% or less, and most preferably 5% or less.

In the fluorophosphate glass, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 10% or less in order to improve the weather resistance of the glass. When the content of these components is 10% or less, problems such as generation of devitrified foreign matters in the glass and deterioration in near-infrared ray cutting property are less likely to occur. The content of these components is preferably 4% or less, more preferably 3% or less, further preferably 2% or less, and still further preferably 1% or less.

Any of Fe₂O₃, Cr₂O₃, Bi₂O₃, NiO, V₂O₅, MnO₂, and CoO is a component that reduces the transmittance of light in the visible region by being present in the glass. Therefore, it is preferable that these components be substantially not contained in the glass. Here, the expression of “substantially not contained in the glass” means that the component is not contained except for unavoidable impurities, and means that the component is not intentionally added. Specifically, it means that a content of each of these components in the glass is about 100 ppm by mass or less.

A thickness of the glass is preferably 3 mm or less, more preferably 2 mm or less, and further preferably 1 mm or less from the viewpoint of ease of optical design when incorporated into a camera module, and the thickness is preferably 0.05 mm or more, and more preferably 0.1 mm or more from the viewpoint of device strength and a necessity of obtaining desired optical characteristics.

### <Barrier Film>

The optical filter according to the present embodiment includes the barrier films 1 and 2 on both main surfaces of the glass.

In the case where the glass is the phosphate glass, the barrier film 1 and the barrier film 2 each independently contain one or more selected from TiO₂, Nb₂O₅, Ta₂O₅, and HfO₂. In the case where the glass is the fluorophosphate glass, the barrier film 1 and the barrier film 2 each independently contain one or more selected from TiO₂, Al₂O₃. Nb₂O₅, Ta₂O₅, and HfO₂.

TiO₂, Al₂O₃, Nb₂O₅, Ta₂O₅, and HfO₂ all have high resistance to moisture, and the presence of the barrier films having such a configuration between the glass and the dielectric multilayer film can prevent elution of the glass under an influence of moisture. From the viewpoint of enhancing the moisture resistance, in the case where the glass is the phosphate glass, the barrier film preferably contains TiO₂, and in the case where the glass is the fluorophosphate glass, the barrier film preferably contains at least one of TiO₂ and Al₂O₃.

A resin material is not preferable as a material of the barrier films 1 and 2 from the viewpoint that a property of preventing penetration of moisture is lowered than that of an inorganic material.

In the case where the glass is the phosphate glass, the barrier film preferably contains one or more selected from TiO₂, Nb₂O₅, Ta₂O₅, and HfO₂ in a total amount of 80 mol % or more, more preferably 90 mol % or more, further preferably 95 mol % or more, and particularly preferably 100 mol %.

Here, the barrier film may contain one or more selected from TiO₂, Nb₂O₅, Ta₂O₅, and HfO₂ alone in an amount of 80 mol % or more, or may contain two or more materials thereof in a total amount of 80 mol % or more.

In the case where the glass is the fluorophosphate glass. the barrier film preferably contains one or more selected from TiO₂, Al₂O₃, Nb₂O₅, Ta₂O₅, and HfO₂ in a total amount of 80 mol % or more, more preferably 90 mol % or more, further preferably 95 mol % or more, and particularly preferably 100 mol %.

Here, the barrier film may contain one or more selected from TiO₂, Al₂O₃, Nb₂O₅, Ta₂O₅, and HfO₂ alone in an amount of 80 mol % or more, or may contain two or more materials thereof in a total amount of 80 mol % or more.

In addition, the barrier film may contain a material other than TiO₂, Al₂O₃, Nb₂O₅, Ta₂O₅, and HfO₂ as long as the resistance to moisture is not impaired. For example, from the viewpoint of adjusting a refractive index of the barrier film, SiO₂ may be contained. On the other hand, a layer containing silicon (Si) may reduce the adhesion to a glass substrate, and thus it is preferable that silicon be not contained as much as possible. In a case where materials other than TiO₂, Al₂O₃, Nb₂O₅, Ta₂O₅, and HfO₂ are contained, the total content thereof is preferably 20 mol % or less. In addition, from the viewpoint of enhancing water resistance of the optical filter, it is preferable that a material other than an oxide of a metal of aluminum (Al), titanium (Ti), niobium (Nb), tantalum (Ta), or hafnium (Hf) be not contained.

The barrier film 2 and the dielectric multilayer film 2 located in the incident direction of the external light preferably have a physical film thickness satisfying a specific condition. That is, when a film including the barrier film 2 and the dielectric multilayer film 2 is defined as a laminated film 2, X represented by the following formula (1) is preferably 35% or more.

$$X ( \% ) = \{ A / ( B - C ) \} \times 100 \qquad ( 1 )$$

In the formula (1), when each layer included in the laminated film 2 is evaluated based on a QWOT represented by the following formula (2), A (nm) is a total thickness of dielectric layers having a QWOT of less than 2 and a refractive index of 1.9 or less included in the laminated film 2, B (nm) is the entire thickness (total physical film thickness) of the laminated film 2. C (nm) is a total thickness of layers having a QWOT of 2 or more in the laminated film 2.

Here, the quarter wave optical thickness (QWOT) is an optical film thickness of λ/4 of a wavelength, and is calculated based on the following formula (2).

$$QWOT = ( thickness of target layer ( nm ) / 550 ( nm ) ) \times 4 \times ( refractive index at 550 nm of target layer ) \qquad ( 2 )$$

The above X means a level of the barrier performance in the laminated film 2, and by controlling X, a combined reflectance of the barrier film 2 and the dielectric multilayer film 2 can be controlled, and an effect of high barrier performance can be obtained.

When X is 35% or more, for example, the maximum reflectance at a wavelength of 450 nm to 750 nm when a light is incident from the light-absorbing layer side shown in the spectral characteristic (i-9) of the optical filter is within a desired range, which is preferable. As described above, by controlling the maximum reflectance when a light is incident from the light-absorbing layer side, intrusion of unnecessary light into a sensor can be prevented. In other words, by providing the barrier film 2 and the dielectric multilayer film 2 in which X satisfies 35% or more, a reflectance on the light-absorbing layer side can be controlled.

X is more preferably 50% or more, and further preferably 70% or more.

The entire thickness B (nm) of the laminated film 2 is obtained by adding the physical film thickness of the barrier film 2 and the physical film thickness of the dielectric multilayer film 2.

The total thickness C (nm) of the layers having a QWOT of 2 or more in the laminated film 2 is obtained by adding the physical film thicknesses of the layers having a QWOT of 2 or more included in the barrier film 2 and the dielectric multilayer film 2.

The total thickness A (nm) of the layers having a QWOT of less than 2 and a refractive index of 1.9 or less in the laminated film 2 is obtained by adding physical film thicknesses of films having a QWOT of less than 2 and a refractive index of 1.9 or less included in the barrier film 2 and the dielectric multilayer film 2.

A thickness of the barrier film 1 is preferably 10 nm or more, and more preferably 20 nm or more from the viewpoint of enhancing the moisture resistance and the like of the optical filter and improving the reliability.

A thickness of the barrier film 2 is preferably 10 nm or more, and more preferably 20 nm or more from the viewpoint of enhancing the moisture resistance and the like of the optical filter and improving the reliability.

A total physical film thickness of the barrier film 1 and the dielectric multilayer film 1 is preferably 1 μm or more, and more preferably 2 μm or more. Such a range is preferable from the viewpoint of improving the water resistance of the optical filter and from the viewpoint of preventing film deformation when a glass surface is altered.

A total physical film thickness of the barrier film 2 and the dielectric multilayer film 2 is preferably 100 nm or more, and more preferably 200 nm or more. Such a range is preferable from the viewpoint of improving the water resistance of the optical filter and from the viewpoint of preventing film deformation when a glass surface is altered.

For formation of the barrier film, for example, a vacuum film formation process such as a CVD method, a sputtering method, or a vacuum deposition method, a wet film formation process such as a spraying method or a dipping method, or the like can be used.

In a case where the laminated film 2 includes a layer containing SiO₂, in the laminated film 2, X′ represented by the following formula (3) may be 35% or more. X′ (%) is more preferably 50% or more, and further preferably 70% or more.

$${X}^{′} ( \% ) = \{ {A}^{′} / ( {B}^{′} - {C}^{′} ) \} \times 100 \qquad ( 3 )$$

In the formula (3),
A′ (nm) is a total thickness of SiO₂ layers having a thickness of 180 nm or less in the laminated film 2,
B′ (nm) is an entire thickness of the laminated film 2, and
C′ (nm) is a total thickness of SiO₂ layers having a thickness larger than 180 nm of the laminated film 2.

### <Dielectric Multilayer Film>

The optical filter according to the present embodiment has the dielectric multilayer film 1 on a barrier film 1 side and the dielectric multilayer film 2 on a barrier film 2 side. Although details will be described later, when a film formed of the barrier film 1 and the dielectric multilayer film 1 is set as a laminated film 1 and when a film formed of the barrier film 2 and the dielectric multilayer film 2 is set as the laminated film 2, it is preferable that at least one of the laminated film 1 and the laminated film 2 be designed as a reflective film (hereinafter, also referred to as “NIR reflective film”) that reflects a part of near-infrared light, and it is more preferable that at least the laminated film 1 be an NIR reflective film from the viewpoint of the shielding properties of the near-infrared light.

The NIR reflective film preferably has, for example, wavelength selectivity of transmitting visible light and mainly reflecting near-infrared light. The NIR reflective film may also be appropriately designed to have a specification further reflecting light in a wavelength range other than the near-infrared light, for example, near ultraviolet light.

The dielectric multilayer film is a laminate of dielectric films having different refractive indices. More specifically, examples of the dielectric films include a dielectric film having a low refractive index (low refractive index film), a dielectric film having a medium refractive index (medium refractive index film), and a dielectric film having a high refractive index (high refractive index film), and the laminate is composed of a dielectric multilayer film in which two or more of those dielectric films are laminated. The reflection characteristics can be adjusted by combining several types of dielectric films having different spectral characteristics when transmitting and selecting a desired wavelength band.

The refractive index of the high refractive index material at a wavelength of 500 nm is preferably 1.8 or more and 3.0 or less, more preferably 1.8 or more and 2.8 or less, and further preferably 1.8 or more and 2.5 or less. Examples of the high refractive index material include Ta₂O₅, TiO₂, TiO, and Nb₂O₅. Other commercially available products thereof include OS50 (Ti₃O₅), OS10 (Ti₄O₇), OA500 (a mixture of Ta₂O₅ and ZrO₂), and OA600 (a mixture of Ta₂O₅ and TiO₂) manufactured by Canon Optron, Inc. Among them, TiO₂ is preferable from the viewpoint of reproducibility in film formability and refractive index, stability, and the like.

The medium refractive index material is a material having a refractive index relatively lower than that of the high refractive index material, and the refractive index at a wavelength of 500 nm is preferably 1.5 or more and 2.0 or less, more preferably 1.5 or more and 1.95 or less, and further preferably 1.5 or more and 1.8 or less. Examples of the medium refractive index material include ZrO₂, Nb₂O₅, Al₂O₃, HfO₂, OM-4 and OM-6 (mixtures of Al₂O₃ and ZrO₂) sold by Canon Optron, Inc., OA-100, and H4 and M2 (alumina lanthania) sold by Merck KGaA. Among them, Al₂O₃-based compounds and mixtures of Al₂O₃ and ZrO₂ are preferable from the viewpoint of reproducibility in film formability and refractive index, stability, and the like.

The low refractive index material is a material having a refractive index relatively lower than that of the medium refractive index material, and the refractive index at a wavelength of 500 nm is preferably 1.3 or more and 1.7 or less, more preferably 1.3 or more and 1.65 or less, and further preferably 1.4 or more and 1.5 or less. Examples of the low refractive index material include SiO₂, SiOₓN_{y}, and MgF₂. Other commercially available products thereof include S4F and S5F (mixtures of SiO₂ and AlO₂) manufactured by Canon Optron, Inc. Among them, SiO₂ is preferable from the viewpoint of reproducibility in film formability, stability, economic efficiency, and the like.

The laminated film 1 including the barrier film 1 and the dielectric multilayer film 1 is preferably designed such that the optical filter satisfies the spectral characteristic (i-6), that is, the maximum reflectance at a wavelength of 850 nm to 1,200 nm is 85% or more at an incident angle of 5 degrees when a light is incident from the dielectric multilayer film 1 side. In addition, the laminated film 1 is preferably designed such that the optical filter satisfies the spectral characteristic (i-10), that is, the average reflectance at a wavelength of 800 nm to 1,100 nm is 95% or more at an incident angle of 5 degrees when a light is incident from the dielectric multilayer film 1 side. The spectral characteristics (i-6) and (i-10) of the optical filter substantially reflect reflection characteristics of the laminated film 1. That is, it is preferable that the laminated film 1 can widely reflect light in the near-infrared region.

In the laminated film 1, the average transmittance at a wavelength of 440 nm to 500 nm is preferably 93% or more at an incident angle of 0 degrees and 84% or more at an incident angle of 60 degrees.

Further, in the laminated film 1, a maximum transmittance at a wavelength of 430 nm to 750 nm is preferably 90% or more at an incident angle of 0 degrees, and a maximum transmittance at a wavelength of 400 nm to 670 nm is preferably 70% or more at an incident angle of 60 degrees.

A film thickness (physical film thickness) of the dielectric multilayer film 1 is preferably 1 μm or more, and more preferably 1.5 μm or more from the viewpoint of reducing the incident angle dependence of the spectral characteristics and from the viewpoint of also having a function of protecting the glass, and is preferably 10 μm or less from the viewpoint of productivity and prevention of reflection ripple in the visible light region.

When the dielectric multilayer film 1 is a thick film of 1 μm or more as a whole, the reflection characteristics are less likely to vary depending on the incident angle. This is because the thicker the film, the less sensitive the interference.

The dielectric multilayer film 1 preferably satisfies the following characteristic (iiA-1).

(iiA-1) The dielectric multilayer film 1 includes a repeating laminated structure represented by (high refractive index layer H_{A}/medium refractive index layer M_{A}/low refractive index layer L_{A}/medium refractive index layer M_{A})ₙ where n represents a natural number of 2 or more, the high refractive index layer H_{A} includes a high refractive index material having a refractive index of 1.8 or more and 3.0 or less at a wavelength of 500 nm, the medium refractive index layer M_{A} includes a medium refractive index material having a refractive index relatively lower than that of the high refractive index material and having a refractive index of more than 1.5 and less than 2.0 at a wavelength of 500 nm, the low refractive index layer LA includes a low refractive index material having a refractive index relatively lower than that of the medium refractive index material and having a refractive index of 1.3 or more and 1.7 or less at a wavelength of 500 nm, and in a case where the medium refractive index layer M_{A} includes the high refractive index layer H_{A} and the low refractive index layer L_{A}, the medium refractive index layer M_{A} is treated as an equivalent film.

When the dielectric multilayer film 1 satisfies the characteristic (iiA-1), a multilayer film capable of widely reflecting light in a near-infrared region is easily obtained, which is preferable.

In addition, n is preferably a natural number of 2 or more, more preferably 3 or more, still more preferably 4 or more, and the larger n is, more preferable it is. When n is within such a range, the repeating laminated structure (H_{A}/M_{A}/L_{A}/M_{A}) is appropriately present, and desired reflection characteristics are obtained. Please note that the repeating laminated structure (H_{A}/M_{A}/L_{A}/M_{A}) has the same meaning as the structure represented by (high refractive index layer H_{A}/medium refractive index layer M_{A}/low refractive index layer L_{A}/medium refractive index layer M_{A}).

A plurality of repeating laminated structures (H_{A}/M/L/M_{A}) may be continuous with each other or separated from each other.

The total number of laminated layers of the dielectric multilayer film 1 is preferably 20 or more, more preferably 30 or more, and further preferably 35 or more. However, when the total number of laminated layers is increased, warpage or the like occurs or the film thickness is increased, so that the total number of laminated layers is preferably 100 or less, more preferably 75 or less, and still more preferably 60 or less.

The laminated film 2 including the barrier film 2 and the dielectric multilayer film 2 is preferably designed such that the optical filter satisfies the spectral characteristics (i-7) and (i-8), that is, the maximum reflectance at a wavelength of 450 nm to 750 nm is 20% or less at an incident angle of 60 degrees and the maximum reflectance at a wavelength of 750 nm to 1,200 nm is 42% or less at an incident angle of 60 degrees when a light is incident from the light-absorbing layer side. The spectral characteristics (i-7) and (i-8) of the optical filter are substantially reflection characteristics of the laminated film 2. That is, the laminated film 2 preferably has low reflection characteristics in the visible light region and the near-infrared region.

A film thickness (physical film thickness) of the dielectric multilayer film 2 is preferably 100 nm or more, and more preferably 150 nm or more from the viewpoint of reducing the incident angle dependence of the spectral characteristics and from the viewpoint of also having a function of protecting the glass, and is preferably 10 μm or less from the viewpoint of productivity and prevention of reflection ripple in the visible light region.

As described above, the dielectric multilayer film 2 serves to protect the glass together with the barrier film 2 and the light-absorbing layer. From such a viewpoint, it is preferable that the film be resistant to film peeling, and that the film be strong even in a system.

The total number of laminated layers of the dielectric multilayer film 2 is preferably 60 or less, more preferably 30 or less, and further preferably 6 or less.

The present filter may include a dielectric multilayer film 3 on at least one outermost surface, preferably on a surface of the light-absorbing layer. From the viewpoint of reducing occurrence of ripples in the visible light region, the dielectric multilayer film 3 is preferably designed as, for example, a near-infrared antireflection film (NIR antireflection film).

The total number of laminated layers of the dielectric multilayer film 3 is preferably 60 or less, more preferably 30 or less, and further preferably 15 or less, and preferably 8 or less. In order to prevent reflection in a visible wavelength band even when the incident angle is changed, a film having a low reflectance in the entire wavelength band is preferable rather than a film that reflects light of a specific wavelength.

A film thickness (physical film thickness) of the dielectric multilayer film 3 is preferably 200 nm to 1,000 nm as a whole.

For formation of the dielectric multilayer film, for example, a vacuum film formation process such as a CVD method, a sputtering method, or a vacuum deposition method, a wet film formation process such as a spraying method or a dipping method, or the like can be used.

### <Light-Absorbing Layer>

The optical filter according to the present embodiment includes a light-absorbing layer provided on or above the dielectric multilayer film 2. The light-absorbing layer contains a near-infrared ray absorbing dye having a maximum absorption wavelength of 680 nm to 800 nm, and can compensate for absorption in a wavelength region in which light is not shielded by the reflection characteristics of the dielectric multilayer film.

From the viewpoint of being able to widely absorb light in the near-infrared region and preventing reduction in transmittance of visible light, it is preferable to combine two or more kinds of near-infrared ray absorbing dyes having different maximum absorption wavelengths in a region of 680 nm to 800 nm, and it is more preferable to combine one or more kinds of near-infrared ray absorbing dyes having a maximum absorption wavelength of 700 nm to 740 nm and one or more kinds of near-infrared ray absorbing dyes having a maximum absorption wavelength of 740 nm to 800 nm.

The near-infrared ray absorbing dye is preferably at least one selected from the group consisting of a squarylium dye, a cyanine dye, a phthalocyanine dye, a naphthalocyanine dye, a dithiol metal complex dye, an azo dye, a polymethine dye, a phthalide dye, a naphthoquinone dye, an anthraquinone dye, an indophenol dye, a pyrylium dye, a thiopyrylium dye, a croconium dye, a tetradehydrocholine dye, a triphenylmethane dye, an aminium dye, and a diimmonium dye.

The near-infrared ray absorbing dye preferably contains at least one dye selected from a squarylium dye, a phthalocyanine dye, and a cyanine dye. Among these dyes, a squarylium dye and a cyanine dye are preferable from the viewpoint of spectroscopy, and a phthalocyanine dye is preferable from the viewpoint of durability.

The light-absorbing layer is preferably a resin film containing the dye and a resin.

A content of the near-infrared ray absorbing dye in the light-absorbing layer is preferably 0.1 parts by mass to 25 parts by mass, and more preferably 0.3 parts by mass to 15 parts by mass with respect to 100 parts by mass of the resin. In a case where two or more compounds are combined, the above content is a sum of respective compounds.

The light-absorbing layer may include other dyes in addition to the above near-infrared ray absorbing dye. Examples of the other dyes preferably include a dye (UV dye) having a maximum absorption wavelength at 370 nm to 440 nm in the resin. Accordingly, light in a near ultraviolet region can be efficiently shielded.

Examples of the UV dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among them, the merocyanine dye is particularly preferred. These dyes may be used alone, or may be used in combination of two or more kinds thereof.

The resin in the light-absorbing layer is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly(p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.

From the viewpoint of spectral characteristics, glass transition point (Tg), and adhesion of the light-absorbing layer, one or more kinds of resins selected from a polyimide resin, a polycarbonate resin, a polyester resin, and an acrylic resin are preferable.

In a case where a plurality of compounds are used as the near-infrared ray absorbing dye or other dyes, those compounds may be included in the same light-absorbing layer or may be included in different light-absorbing layers.

The light-absorbing layer can be formed by dissolving or dispersing a dye, a resin or raw material components of the resin, and respective components blended as necessary in a solvent to prepare a coating solution, applying the coating solution on the dielectric multilayer film 2, drying the coating solution, and further curing the coating solution as necessary. Alternatively, the coating solution may be applied to a peelable support used only when the light-absorbing layer is formed, and the light-absorbing layer may be laminated on the dielectric multilayer film 2 later. The solvent may be a dispersion medium capable of stably dispersing components or a solvent capable of dissolving components.

The coating solution may contain a surfactant in order to improve voids due to fine bubbles, depressions due to adhesion of foreign matters and the like, and repelling in a drying step. Further, for the application of the coating solution, for example, a dip coating method, a cast coating method, or a spin coating method can be used. When the coating solution contains a raw material component of the transparent resin, a curing process such as thermal curing or photocuring is further performed.

The light-absorbing layer can also be manufactured into a film shape by extrusion molding. The present filter can be manufactured by laminating the obtained film-shaped absorbing layer on the dielectric multilayer film 2 and integrating those by thermal press fitting or the like.

The light-absorbing layer may be provided in the optical filter by one layer or two or more layers. In a case where the light-absorbing layer is provided by two or more layers, each of the layers may have the same configuration or a different configuration, and two or more layers may be stacked on or above one of the dielectric multilayer films even when the light-absorbing layers are formed on or above each of the dielectric multilayer films.

A thickness of the light-absorbing layer is 10 μm or less and preferably 5 μm or less from the viewpoint of in-plane film thickness distribution and appearance quality in a substrate after coating, and is preferably 0.5 μm or more from the viewpoint of exhibiting desired spectral characteristics at an appropriate dye concentration. In a case where the optical filter has two or more layers of light-absorbing layers, a total thickness of the respective light-absorbing layers is preferably within the above range.

The optical filter according to the present embodiment may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have a high transmittance of visible light and have light absorbing properties in a wide range of an infrared wavelength region exceeding 1,200 nm, and thus can be used in the case where light-shielding properties of infrared light are required.

### <Imaging Device>

The imaging device according to an embodiment of the present invention preferably includes the optical filter according to an embodiment of the present invention described above. The imaging device preferably further includes a solid state image sensor and an imaging lens. The optical filter according to the present embodiment can be used, for example, by being disposed between the imaging lens and the solid state image sensor, or by being directly attached to the solid state image sensor, the imaging lens, or the like of the imaging device via an adhesive layer. By providing the present filter which is excellent in transmittance of visible light, has shielding properties of specific near-infrared light, and has a spectral curve hardly shifted even at a high incident angle, an imaging device excellent in color reproducibility even for light at a high incident angle can be obtained.

When the optical filter is to be mounted on the imaging device, it is usually preferable that the dielectric multilayer film 1 be on a lens side (external light incident side) and the dielectric multilayer film 2 be on a sensor side.

As described above, the present description discloses the following optical filter and the like.

[1] An optical filter including: a glass:
a glass;
a dielectric multilayer film 1 and a dielectric multilayer film 2 provided on both surface sides of the glass;
a barrier film 1 provided between the glass and the dielectric multilayer film 1;
a barrier film 2 provided between the glass and the dielectric multilayer film 2; and
a light-absorbing layer provided on or above the dielectric multilayer film 2, in which
the glass is a phosphate glass having near-infrared ray absorbing properties and being substantially free from fluorine atoms, or a fluorophosphate glass having near-infrared ray absorbing properties and including a fluorine atom,
the light-absorbing layer includes a near-infrared ray absorbing dye having a maximum absorption wavelength at 680 nm to 800 nm,
in a case where the glass is the phosphate glass, the barrier film 1 and the barrier film 2 each independently include one or more selected from TiO₂, Nb₂O₅, Ta₂O₅, and HfO₂,
in a case where the glass is the fluorophosphate glass, the barrier film 1 and the barrier film 2 each independently include one or more selected from TiO₂, Al₂O₃, Nb₂O₅, Ta₂O₅, and HfO₂, and
the optical filter satisfies all of the following spectral characteristics (i-1) to (i-3) and (i-6):
(i-1) an average transmittance at a wavelength of 440 nm to 500 nm is 80% or more at an incident angle of 0 degrees and 70% or more at an incident angle of 60 degrees,
(i-2) an average transmittance at a wavelength of 750 nm to 1,000 nm is 1% or less at an incident angle of 0 degrees and 1% or less at an incident angle of 60 degrees,
(i-3) in a spectral transmittance curve at an incident angle of 0 degrees, a wavelength IR10_{(0deg)} at which a transmittance is 10% is in a range of 600 nm to 700 nm, and
(i-6) when a light is incident from a dielectric multilayer film 1 side, a maximum reflectance at a wavelength of 850 nm to 1,200 nm is 85% or more at an incident angle of 5 degrees.

[2] The optical filter according to [1], in which
the optical filter satisfies the following spectral characteristics (i-4) and (i-5):
(i-4) an absolute value of a difference between the wavelength IR10_{(0deg)} at which the transmittance is 10% in the range of 600 nm to 700 nm in the spectral transmittance curve at an incident angle of 0 degrees and a wavelength IR10_{(60deg)} at which a transmittance is 10% in the range of 600 nm to 700 nm in a spectral transmittance curve at an incident angle of 60 degrees is 20 nm or less, and
(i-5) a transmittance at a wavelength of 1,100 nm is 1% or less at an incident angle of 0 degrees and 3% or less at an incident angle of 60 degrees.

[3] The optical filter according to [1] or [2], in which
the optical filter satisfies the following spectral characteristics (i-7) and (i-8): (i-7) when a light is incident from a light-absorbing layer side, a maximum reflectance at a wavelength of 450 nm to 750 nm is 20% or less at an incident angle of 60 degrees, and
(i-8) when a light is incident from the light-absorbing layer side, a maximum reflectance at a wavelength of 750 nm to 1,200 nm is 42% or less at an incident angle of 60 degrees.

[4] The optical filter according to any of [1] to [3], in which
when a film formed of the barrier film 2 and the dielectric multilayer film 2 is defined as a laminated film 2,
X represented by the following formula (1) is 35% or more,

$$X ( \% ) = \{ A / ( B - C ) \} \times 100 \qquad ( 1 )$$

here, when each layer included in the laminated film 2 is evaluated based on a QWOT represented by the following formula (2),
A (nm) is a total thickness of layers having a QWOT of less than 2 and a refractive index of 1.9 or less in the laminated film 2,

$$QWOT = ( thickness of target layer ( nm ) / 550 ( nm ) ) \times 4 \times ( refractive index at wavelength 550 nm of target layer ) \qquad ( 2 )$$

B (nm) is an entire thickness of the laminated film 2, and
C (nm) is a total thickness of layers having a QWOT of 2 or more in the laminated film 2.

[5] The optical filter according to any of [1] to [4], in which
the optical filter satisfies the following spectral characteristic (i-9):
(i-9) when a light is incident from a light-absorbing layer side, a maximum reflectance at a wavelength of 450 nm to 750 nm is 7.5% or less at an incident angle of 5 degrees.

[6] The optical filter according to any of [1] to [5], in which
the optical filter satisfies the following spectral characteristic (i-10):
(i-10) when a light is incident from the dielectric multilayer film 1 side, an average reflectance at a wavelength of 800 nm to 1,100 nm is 95% or more at an incident angle of 5 degrees.

[7] The optical filter according to any of [1] to [6], in which
the phosphate glass is substantially free from fluorine atoms, and
the phosphate glass includes, in terms of mol % based on oxides,
40% to 75% of P₂O₅,
10% to 30% of Al₂O₃,
0.1% to 30% of ΣR₂₀ where R₂O is one or more components selected from Li₂O, Na₂O, K₂O, Rb₂O, and Cs₂O, and ΣR₂₀ is a total content of R₂O,
0% to 30% of ΣR′O where R′O is one or more components selected from CaO, MgO, BaO, SrO, and ZnO, and ΣR′O is a total content of R′O, and
2% to 30% of CuO.

[8] The optical filter according to any of [1] to [6], in which
the fluorophosphate glass includes, in terms of mass %,
20% to 70% of P^{5+,}
1% to 20% of Al³⁺,
0% to 30% of Li+,
0% to 40% of Na⁺,
0% to 40% of K,
0% to 20% of Rb⁺,
0% to 20% of Cs⁺,
0% to 20% of Mg²⁺,
0% to 20% of Ca²⁺,
0% to 30% of Sr²⁺,
0% to 40% of Ba²⁺,
1% to 55% of ΣR⁺where R⁺is one or more components selected from Li⁺, Na⁺, K⁺, Rb⁺, and Cs⁺, 1% to 50% of ΣR²⁺ where R²⁺ is one or more components selected from Mg²⁺, Ca²⁺, Sr²⁺, and Ba²⁺,
1% to 20% of Cu²⁺, and
0% to 20% of Zn²⁺, and
the fluorophosphate glass includes, in terms of outer percentage, 3 mass % to 60 mass % of F⁻ when a content of a component element other than F⁻included in the glass is set to 100 mass %.

[9] The optical filter according to any of [1] to [8], in which
the glass has, in terms of a plate thickness of 0.2 mm,
a transmittance of 80% or more at a wavelength of 420 nm,
a transmittance of 6% or less at a wavelength of 800 nm, and
a transmittance of 25% or less at a wavelength of 1,200 nm.

[10] The optical filter according to any of [1] to [9], in which
the dielectric multilayer film 1 satisfies the following characteristic (iiA-1):
(iiA-1) the dielectric multilayer film 1 includes a repeating laminated structure represented by (high refractive index layer H_{A}/medium refractive index layer M_{A}/low refractive index layer L_{A}/medium refractive index layer M_{A})ₙ where
n represents a natural number of 2 or more,
the high refractive index layer H_{A} includes a high refractive index material having a refractive index of 1.8 or more and 3.0 or less at a wavelength of 500 nm,
the medium refractive index layer M_{A} includes a medium refractive index material having a refractive index relatively lower than that of the high refractive index material and having a refractive index of 1.5 or more and 2.0 or less at a wavelength of 500 nm,
the low refractive index layer LA includes a low refractive index material having a refractive index relatively lower than that of the medium refractive index material and having a refractive index of 1.3 or more and 1.7 or less at a wavelength of 500 nm, and
in a case where the medium refractive index layer M_{A} includes the high refractive index layer H_{A} and the low refractive index layer L_{A}, the medium refractive index layer M_{A} is treated as an equivalent film.

[11] The optical filter according to any of [1] to [10], in which
in the case where the glass is the phosphate glass, the barrier film 1 and the barrier film 2 contain TiO₂, and
in the case where the glass is the fluorophosphate glass, the barrier film 1 and the barrier film 2 each independently contain at least one of TiO₂ and Al₂O₃.

[12] The optical filter according to any of [1] to [11], in which
the light-absorbing layer includes:
one or more near-infrared ray absorbing dyes having a maximum absorption wavelength in a range of 700 nm or more and less than 740 nm; and
one or more near-infrared ray absorbing dyes having a maximum absorption wavelength in a range of 740 nm or more and 800 nm or less.

[13] An imaging device including the optical filter according to any of [1] to [12].

### EXAMPLES

Next, the present invention is described more specifically with reference to examples.

For measurement of each spectral characteristic, an ultraviolet-visible spectrophotometer (UH-4150 type, manufactured by Hitachi High-Tech Corporation) was used.

The spectral characteristic in the case where an incident angle is not particularly specified is a value measured at an incident angle of 0 degrees (in a direction perpendicular to a main surface of an optical filter).

Dyes used in respective examples are as follows.

Compound 1 (cyanine compound): synthesized based on Dyes and pigments 73 (2007) 344-352.

Compound 2 (merocyanine compound): synthesized based on the description of German Patent No. 10109243.

Compound 3 (squarylium compound): synthesized based on WO2017/135359.

Compound 4 (squarylium compound): synthesized based on WO2014/088063 and WO2016/133099.

Compound 5 (merocyanine compound): synthesized based on the description of German Patent No. 10109243.

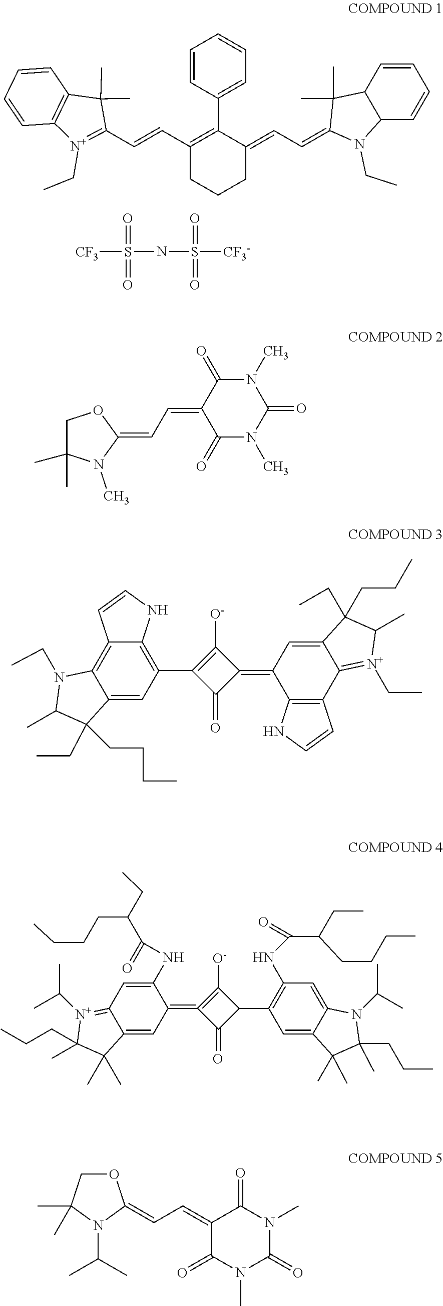

The compounds 1, 3, and 4 are near-infrared ray absorbing dyes (NIR dyes), and the compounds 2 and 5 are near ultraviolet absorbing dyes (UV dyes). The maximum absorption wavelength of each dye is shown in Table 7 below.

### <Spectral Characteristics of Glass>

The following glass was prepared.

As a phosphate glass or a fluorophosphate glass, raw materials were weighed and mixed so as to have contents shown in Table 1 or 2 in terms of mol % based on oxides or in terms of mass %, placed in a crucible having an internal volume of about 400 mL, and melted under a reducing atmosphere for 2 hours. Thereafter, the mixture was refined, stirred, and cast into a rectangular mold of 100 mm length×80 mm width×20 mm height that was preheated to about 300° C. to 500° C., and then slowly cooled at about 1° C./min to obtain a glass of a plate-shaped sample having both surfaces optically polished.

Spectral characteristics of each glass are shown in Tables 1 and 2 below.

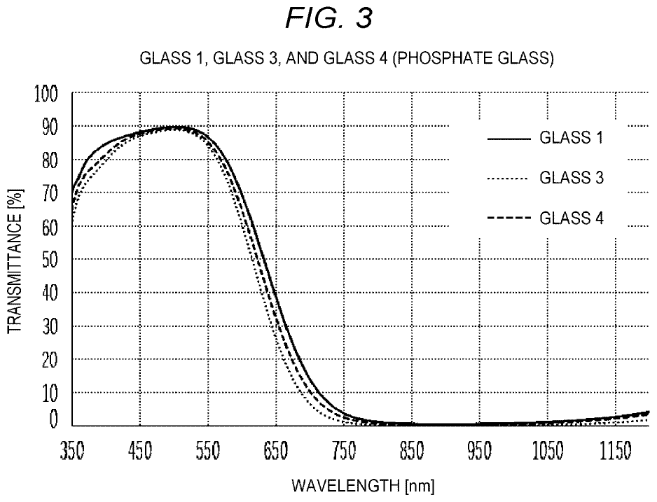

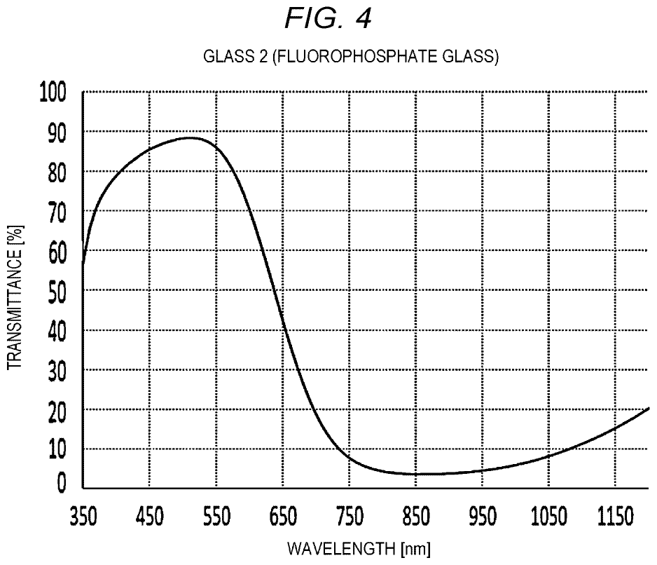

In addition, spectral transmittance curves of respective glasses are each illustrated in FIGS. 3 and 4.

TABLE 1

| | | Glass 1 | Glass 3 | Glass 4 |
|---|---|---|---|---|
| Glass | Glass type | Phosphate | Phosphate | Phosphate |
| | Plate thickness [mm] | 0.29 | 0.3 | 0.25 |
| Glass | P₂O₅ | 57.69 | 57.54 | 57.54 |
| composition | Al₂O₃ | 13.27 | 13.24 | 13.24 |
| [mol %] | LiO₂ | — | — | — |
| | Na₂O | 6.08 | 6.07 | 6.07 |
| | K₂O | 11.46 | 8.49 | 8.49 |
| | ZnO | — | — | — |
| | SnO₂ | — | — | — |
| | MoO₃ | — | 0.25 | 0.25 |
| | MgO | — | — | — |
| | CaO | — | — | — |
| | SrO | — | — | — |
| | BaO | — | — | — |
| | CuO | 11.50 | 14.41 | 14.41 |
| | F | — | — | — |
| Total | | 100.0 | 100.0 | 100.0 |
| Spectral | 0 deg incident light | 86.3 | 83.7 | 84.9 |
| characteristics | Transmittance at | | | |
| of glass | wavelength of 420 nm [%] | | | |
| | 0 deg incident light | 1.0 | 0.3 | 0.7 |
| | Transmittance at | | | |
| | wavelength of 800 nm [%] | | | |
| | 0 deg incident light | 4.0 | 3.5 | 1.8 |
| | Transmittance at | | | |
| | wavelength of 1,200 nm [%] | | | |
| | IR50 [nm] | 632 | 615 | 623 |

TABLE 2

| | | Glass 2 |
|---|---|---|
| Glass | Glass type | Fluorophosphate |
| | Plate thickness [mm] | 0.2 |
| Glass | P | 35.3 |
| composition | Al | 6.5 |
| [mass %] | Li | — |
| | Na | — |
| | K | 24.2 |
| | Rb | — |
| | Cs | — |
| | Mg | — |
| | Ca | 4.3 |
| | Sr | 6.8 |
| | Ba | 14.4 |
| | Cu | 8.4 |
| | Zn | — |
| Total | | 100 |
| Amount of F in | After vitrification - | — |
| terms of outer | estimated F wt % | |
| percentage | After vitrification - | 14.90 |
| (mass %) | measured F wt % | |
| [R⁺] ionic radius | | 133.0 |
| Spectral | 0 deg incident light | 82.1 |
| characteristics | Transmittance at | |
| of glass | wavelength of 420 nm [%] | |
| | 0 deg incident light | 4.4 |
| | Transmittance at | |
| | wavelength of 800 nm [%] | |
| | 0 deg incident light | 20.3 |
| | Transmittance at | |
| | wavelength of 1,200 nm [%] | |
| | IR50 [nm] | 636 |

As described above, it is understood that both the glasses 1, 3, and 4 (phosphate glasses) and the glass 2 (fluorophosphate glass) are excellent in transmittance of visible light and can absorb near-infrared light over a wide range of 800 nm to 1,200 nm.

### <Reliability Test 1 of Glass>

A test piece having a length of 5 mm, a width of 5 mm, and a thickness of 0.29 mm of the glass 1 manufactured as described above was prepared, and materials shown in Table 3 below were laminated on both main surfaces by vapor deposition to form a barrier film.

The glass substrate with the barrier film was subjected to a high-temperature and high-humidity test under the following conditions.

After the glass substrate with the barrier film was allowed to stand under an environment of a temperature of 85° C., and a relative humidity of 85% for a time shown in Table 3, an end surface was observed with a metal microscope at a magnification of 200 from a main surface side to evaluate the degree of deterioration. A distance from the end surface of a most deteriorated portion was measured and evaluated based on the following criteria. B or better is regarded as acceptable.
A: deterioration of end surface was less than 150 μm
B: deterioration of end surface was 150 μm or more and less than 200 μm
C: deterioration of end surface was 200 μm or more

Evaluation results are shown in Table 3 below.

Examples 1-1 and 1-2 are reference inventive examples, and Examples 1-3 to 1-5 are reference comparative examples.

TABLE 3

| | | | Example 1-1 | Example 1-2 | Example 1-3 | Example 1-4 | Example 1-5 |
|---|---|---|---|---|---|---|---|
| Sample | Barrier | Film material | TiO₂ | Ta₂O₅ | Al₂O₃ | SiO₂ | ZrO₂ |
| conditions | film | Thickness [nm] | 143 | 143 | 143 | 143 | 143 |
| | Glass | Type | Glass 1 | Glass 1 | Glass 1 | Glass 1 | Glass 1 |
| | | Thickness [nm] | 0.29 | 0.29 | 0.29 | 0.29 | 0.29 |
| | Barrier | Film material | TiO₂ | Ta₂O₅ | Al₂O₃ | SiO₂ | ZrO₂ |
| | film | Thickness [nm] | 143 | 143 | 143 | 143 | 143 |

| | | | | | | |
|---|---|---|---|---|---|---|
| Results of | Test time | | | | | |
| reliability | 100 hours | A | A | C | C | C |
| test | 250 hours | A | B | C | C | C |

From the above results, it is understood that with respect to the glass 1 (phosphate glass), a barrier film made of titania or tantalum has excellent durability, and particularly, titania is preferable. On the other hand, in a barrier film made of alumina, silica, or zirconia, deterioration of the end surface was confirmed, and durability was not obtained.

### <Reliability Test 2 of Glass>

A test piece having a length of 5 mm, a width of 5 mm, and a thickness of 0.29 mm of the glass 1 manufactured as described above was prepared, and TiO₂ was laminated on both main surfaces by vapor deposition to form a barrier film. Further, SiO₂ and TiO₂ were alternately laminated on a surface of each barrier film by vapor deposition to form a dielectric multilayer film A or B having a configuration shown in Table 5. A film number 1 is a layer in contact with the barrier film.

With respect to the obtained test piece, the degree of deterioration of the end surface was evaluated by the same method and reference as in the reliability test 1 of glass.

Evaluation results are shown in Table 4 below.

Examples 1-6 and 1-7 are reference inventive examples.

TABLE 4

| | | | Example | Example |
|---|---|---|---|---|
| | | | 1-6 | 1-7 |
| Sample | Dielectric | Type | Film A | Film B |
| conditions | multilayer | | | |
| | film | | | |
| | Barrier film | Film material | TiO₂ | TiO₂ |
| | | Thickness [nm] | 11.49 | 11.49 |
| | Glass | Type | Glass 1 | Glass 1 |
| | | Thickness [mm] | 0.29 | 0.29 |
| | Barrier film | Film material | TiO₂ | TiO₂ |
| | | Thickness [nm] | 11.49 | 11.49 |
| | Dielectric | Type | Film A | Film B |
| | multilayer | | | |
| | film | | | |

| | Thickness of dielectric multilayer | 1,645 | 645 |
|---|---|---|---|
| | film + barrier film [nm] | | |
| Results of | Test time | | |
| reliability | 100 hours | A | A |
| test | 250 hours | A | B |

TABLE 5

| Dielectric multilayer film A | | | Dielectric multilayer film B | | |
|---|---|---|---|---|---|
| Film | Film | Physical film | Film | Film | Physical film |
| number | material | thickness [nm] | number | material | thickness [nm] |
| Barrier film side | | | Barrier film side | | |
| 1 | SiO₂ | 57.88 | 1 | SiO₂ | 57.88 |
| 2 | TiO₂ | 23.98 | 2 | TiO₂ | 23.98 |
| 3 | SiO₂ | 60.37 | 3 | SiO₂ | 60.37 |
| 4 | TiO₂ | 20.17 | 4 | TiO₂ | 20.17 |
| 5 | SiO₂ | 89.86 | 5 | SiO₂ | 89.86 |
| 6 | TiO₂ | 12.96 | 6 | TiO₂ | 12.96 |
| 7 | SiO₂ | 80.19 | 7 | SiO₂ | 80.19 |
| 8 | TiO₂ | 26.77 | 8 | TiO₂ | 26.77 |
| 9 | SiO₂ | 28.54 | 9 | SiO₂ | 28.54 |
| 10 | TiO₂ | 80.07 | 10 | TiO₂ | 80.07 |
| 11 | SiO₂ | 13.91 | 11 | SiO₂ | 13.91 |
| 12 | TiO₂ | 31.37 | 12 | TiO₂ | 31.37 |
| 13 | SiO₂ | 1,107.65 | 13 | SiO₂ | 107.65 |

| | | | |
|---|---|---|---|
| Entire film | 1,633.72 | Entire film | 633.72 |
| thickness [nm] | | thickness [nm] | |

According to results of the above Examples 1-6 and 1-7, the durability of the barrier film could be confirmed in any of the phosphate glasses.

In addition, it could be confirmed that Example 1-6 in which a total film thickness of the barrier film and the dielectric multilayer film was large had higher durability.

### <Reliability Test 3 of Glass>

A test piece having a length of 5 mm, a width of 5 mm, and a thickness of 0.225 mm of the glass 2 (fluorophosphate glass) manufactured as described above was prepared, and TiO₂ or Al₂O₃ was laminated on both main surfaces by vapor deposition to form a barrier film. Further, SiO₂ and TiO₂ were alternately laminated on a surface of each barrier film by vapor deposition to form a dielectric multilayer film A or B having a configuration shown in Table 6. A film number 1 is a layer in contact with the barrier film.

The obtained test piece was subjected to a high-temperature and high-humidity test under the following conditions.

After the glass substrate with the barrier film was allowed to stand under an environment of a temperature of 85° C., and a relative humidity of 85% for a time shown in Table 3, an end surface was observed with a metal microscope at a magnification of 200 from a main surface side to evaluate the degree of deterioration. A distance from the end surface of a most deteriorated portion was measured and evaluated based on the following criteria. C or better is regarded as acceptable.
A: deterioration of end surface was less than 100 μm
B: deterioration of end surface was 100 μm or more and less than 150 μm
C: deterioration of end surface was 150 μm or more and less than 250 μm
D: deterioration of end surface was 250 μm or more

Evaluation results are shown in Table 6 below.

Examples 1-8 and 1-9 are reference inventive examples, and Example 1-10 is a reference comparative example.

TABLE 6

| | | | Example | Example | Example |
|---|---|---|---|---|---|
| | | | 1-8 | 1-9 | 1-10 |
| Sample | Dielectric | Type | Film A | Film B | — |
| conditions | multilayer | | | | |
| | film | | | | |
| | Barrier film | Film material | TiO₂ | Al₂O₃ | — |
| | | Thickness [nm] | 12 | 12 | 0 |
| | Glass | Type | Glass 2 | Glass 2 | Glass 2 |
| | | Thickness [mm] | 0.225 | 0.225 | 0.225 |
| | Barrier film | Film material | TiO₂ | Al₂O₃ | — |
| | | Thickness [nm] | 12 | 12 | 0 |
| | Dielectric | Type | Film A | Film B | — |
| | multilayer | | | | |
| | film | | | | |
| | Thickness of dielectric multilayer | | 2,815 | 2,803 | 0 |
| | film + barrier film [nm] | | | | |
| Results of | Test time | | | | |
| reliability | 1,000 hours | | B | C | D |
| test | | | | | |

From the results of Examples 1-8 to 1-9, it was understood that the durability of the fluorophosphate glass could be confirmed even when any barrier film of TiO₂ or Al₂O₃ was used, and Example 1-8 using TiO₂ was more preferable.

### <Spectral Characteristics of Light-absorbing Layer>

The dyes of the compounds 1 to 5 were dissolved in a polyimide resin C-3G30G manufactured by Mitsubishi Gas Chemical Company, Inc., mixed at a concentration shown in Table 7 below, and stirred and dissolved at 50° C. for 2 hours to obtain a coating solution. The obtained coating solution was applied onto an alkaline glass (D263 glass, manufactured by SCHOTT, thickness: 0.2 mm) by a spin coating method to form light-absorbing layers 1 and 2 each having a film thickness of 1 μm.

With respect to the obtained light-absorbing layers 1 and 2, spectral transmittance curves and spectral reflectance curves in a wavelength range of 350 nm to 1,200 nm were measured using the ultraviolet-visible spectrophotometer.

Results are shown in Table 7 below.

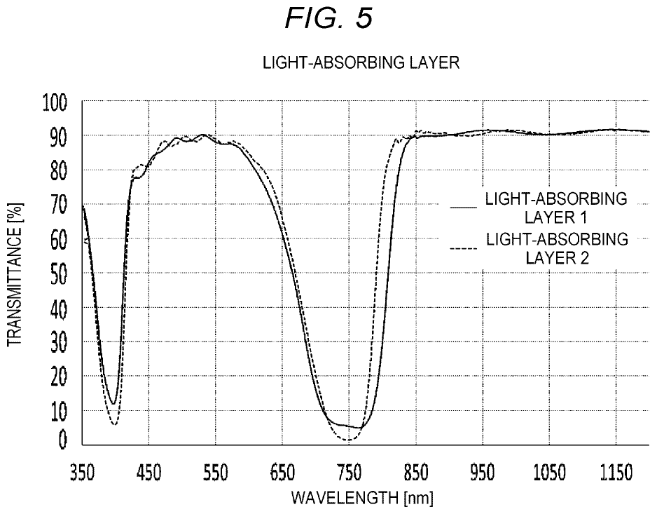

In addition, the spectral transmittance curves of the light-absorbing layers are illustrated in FIG. 5.

TABLE 7

| | | Light- | Light- |
|---|---|---|---|
| | | absorbing | absorbing |
| | | layer 1 | layer 2 |
| Dye addition | Compound 1 (λMAX: 772 nm) | 4.16 | — |
| amount (mass %) | Compound 2 (λMAX: 397 nm) | 3.24 | — |
| | Compound 3 (λMAX: 752 nm) | 1.17 | 5.24 |
| | Compound 4 (λMAX: 722 nm) | 2.21 | 1.47 |
| | Compound 5 (λMAX: 400 nm) | — | 4.86 |
| | Total | 10.8 | 11.6 |
| Spectral characteristics | 0 deg incident light | 86.88 | 87.23 |
| of light-absorbing layer | Average transmittance at wavelength of 440 nm to | | |
| | 600 nm [%] | | |
| | 0 deg incident light | 665 | 670 |
| | Wavelength at which transmittance at wavelength of | | |
| | 500 nm to 700 nm is 50% [nm] | | |
| | 0 deg incident light | 60 | 57 |
| | Absolute value of difference between wavelength at | | |
| | which transmittance is 20% and wavelength at which | | |
| | transmittance is 70% at wavelength of 500 nm to 700 | | |
| | nm [nm] | | |
| | 0 deg incident light | 9.02 | 14.26 |
| | Average transmittance at wavelength of 700 nm to | | |
| | 800 nm [%] | | |

### Example 2-1: Spectral Characteristics of Optical Filter

A barrier film 1 and a barrier film 2 were each formed by laminating TiO₂ on both main surfaces of the glass 1 (phosphate glass) by vapor deposition with the same composition as in Example 1-1.

A dielectric multilayer film 1A having a configuration shown in Table 8 was formed by alternately laminating SiO₂ and TiO₂ on a surface of the barrier film 1 by vapor deposition.

A dielectric multilayer film 2A having a configuration shown in Table 11 was formed by alternately laminating SiO₂ and TiO₂ on a surface of the barrier film 2 by vapor deposition.

With the same composition as that of the light-absorbing layer 1, a resin solution was applied to a surface of the barrier film 2, and an organic solvent was removed by sufficiently heating to form a light-absorbing layer 1 having a thickness of 1 μm.

A dielectric multilayer film 3A (antireflection film) having a configuration shown in Table 13 was formed by alternately laminating SiO₂ and TiO₂ on a surface of the light-absorbing layer by vapor deposition.

Thus, an optical filter 2-1 was manufactured.

### Example 2-2

An optical filter 2-2 was manufactured in the same manner as in Example 2-1 except that a dielectric multilayer film 2B having a configuration shown in Table 11 was formed instead of the dielectric multilayer film 2A and a thickness of the barrier film 2 was changed to a value shown in Table 14.

### Example 2-3

A barrier film 1 and a barrier film 2 were each formed by laminating Al₂O₃ on both main surfaces of the glass 2 (fluorophosphate glass) by vapor deposition with the same composition as in Example 1-9.

A dielectric multilayer film 1B having a configuration shown in Table 8 was formed by alternately laminating SiO₂ and TiO₂ on a surface of the barrier film 1 by vapor deposition. A dielectric multilayer film 2C having a configuration shown in Table 11 was formed by alternately laminating SiO₂ and TiO₂ on a surface of the barrier film 2 by vapor deposition.

With the same composition as that of the light-absorbing layer 1, a resin solution was applied to a surface of the barrier film 2-2, and an organic solvent was removed by sufficiently heating to form a light-absorbing layer having a thickness of 1 μm.

A dielectric multilayer film 3A (antireflection film) having a configuration shown in Table 13 was formed by alternately laminating SiO₂ and TiO₂ on a surface of the light-absorbing layer by vapor deposition.

Thus, an optical filter 2-3 was manufactured.

### Example 2-4

An optical filter 2-4 was manufactured in the same manner as in Example 2-1 except that a dielectric multilayer film 1C having a configuration shown in Table 9 was formed instead of the dielectric multilayer film 1A.

### Example 2-5

An optical filter 2-5 was manufactured in the same manner as in Example 2-3 except that a dielectric multilayer film 1D having a configuration shown in Table 10 was formed instead of the dielectric multilayer film 1B.

### Example 2-6

An optical filter 2-6 was manufactured in the same manner as in Example 2-1 except that a dielectric multilayer film 2D having a configuration shown in Table 11 was formed instead of the dielectric multilayer film 2A and the thickness of the barrier film 2 was changed to a value shown in Table 15.

### Example 2-7

An optical filter 2-7 was manufactured in the same manner as in Example 2-1 except that a dielectric multilayer film 2E having a configuration shown in Table 12 was formed instead of the dielectric multilayer film 2A and the thickness of the barrier film 2 was changed to a value shown in Table 15.

### Example 2-8

An optical filter 2-8 was manufactured in the same manner as in Example 2-1 except that a dielectric multilayer film 2F having a configuration shown in Table 12 was formed instead of the dielectric multilayer film 2A and the thickness of the barrier film 2 was changed to a value shown in Table 15.

### Example 2-9

A barrier film 1 and a barrier film 2 were each formed by laminating Al₂O₃ on both main surfaces of the glass 1 (phosphate glass) by vapor deposition with the same composition as in Example 1-9.

A dielectric multilayer film 1B having a configuration shown in Table 8 was formed by alternately laminating SiO₂ and TiO₂ on a surface of the barrier film 1 by vapor deposition. A dielectric multilayer film 2G having a configuration shown in Table 12 was formed by alternately laminating SiO₂ and TiO₂ on a surface of the barrier film 2 by vapor deposition.

With the same composition as that of the light-absorbing layer 1, a resin solution was applied to a surface of the barrier film 2, and an organic solvent was removed by sufficiently heating to form a light-absorbing layer having a thickness of 1 μm.

A dielectric multilayer film 3A (antireflection film) having a configuration shown in Table 13 was formed by alternately laminating SiO₂ and TiO₂ on a surface of the light-absorbing layer by vapor deposition.

Thus, an optical filter 2-9 was manufactured.

### Example 2-10

A barrier film 1 and a barrier film 2 were each formed by laminating TiO₂ on both main surfaces of the glass 3 (phosphate glass) by vapor deposition with the same composition as in Example 1-8.

A dielectric multilayer film 1E having a configuration shown in Table 10 was formed by alternately laminating SiO₂ and TiO₂ on a surface of the barrier film 1 by vapor deposition.

A dielectric multilayer film 2H having a configuration shown in Table 12 was formed by alternately laminating SiO₂ and TiO₂ on a surface of the barrier film 2 by vapor deposition.

With the composition of the light-absorbing layer 2, a resin solution was applied to a surface of the barrier film 2, and an organic solvent was removed by sufficiently heating to form a light-absorbing layer having a thickness of 1 μm.

A dielectric multilayer film 3B (antireflection film) having a configuration shown in Table 13 was formed by alternately laminating SiO₂ and TiO₂ on a surface of the light-absorbing layer by vapor deposition.

Thus, an optical filter 2-10 was manufactured.

### Example 2-11

An optical filter 2-11 was manufactured in the same manner as in Example 2-10 except that the glass 3 was changed to a glass 4 shown in Table 1.

TABLE 8

| Dielectric multilayer film 1A | | | | Dielectric multilayer film 1B | | | |
|---|---|---|---|---|---|---|---|
| | | Physical film | QWOT at | | | Physical film | QWOT at |
| | Film | thickness | wavelength | | Film | thickness | wavelength |
| No | material | [nm] | of 550 nm | No | material | [nm] | of 550 nm |
| Barrier film 1 side | | | | Barrier film 1 side | | | |
| 1 | SiO₂ | 35.93 | 0.387 | 1 | TiO₂ | 13.48 | 0.237 |
| 2 | TiO₂ | 123.67 | 2.178 | 2 | SiO₂ | 31.85 | 0.343 |
| 3 | SiO₂ | 36.3 | 0.391 | 3 | TiO₂ | 126.73 | 2.232 |
| 4 | TiO₂ | 27.74 | 0.489 | 4 | SiO₂ | 37.06 | 0.399 |
| 5 | SiO₂ | 38.18 | 0.411 | 5 | TiO₂ | 26.93 | 0.474 |
| 6 | TiO₂ | 127.01 | 2.237 | 6 | SiO₂ | 40.57 | 0.437 |
| 7 | SiO₂ | 39.15 | 0.421 | 7 | TiO₂ | 126.37 | 2.226 |
| 8 | TiO₂ | 26.07 | 0.459 | 8 | SiO₂ | 42.19 | 0.454 |
| 9 | SiO₂ | 38.05 | 0.409 | 9 | TiO₂ | 24.6 | 0.433 |
| 10 | TiO₂ | 123.01 | 2.167 | 10 | SiO₂ | 39.92 | 0.430 |
| 11 | SiO₂ | 34.74 | 0.374 | 11 | TiO₂ | 121.87 | 2.146 |
| 12 | TiO₂ | 26.83 | 0.473 | 12 | SiO₂ | 32.92 | 0.354 |
| 13 | SiO₂ | 35.39 | 0.381 | 13 | TiO₂ | 26.85 | 0.473 |
| 14 | TiO₂ | 125.28 | 2.207 | 14 | SiO₂ | 33.03 | 0.355 |
| 15 | SiO₂ | 39.21 | 0.422 | 15 | TiO₂ | 125.03 | 2.202 |
| 16 | TiO₂ | 26.53 | 0.467 | 16 | SiO₂ | 37.83 | 0.407 |
| 17 | SiO₂ | 40.49 | 0.436 | 17 | TiO₂ | 27.15 | 0.478 |
| 18 | TiO₂ | 129.92 | 2.288 | 18 | SiO₂ | 38.9 | 0.419 |
| 19 | SiO₂ | 40.71 | 0.438 | 19 | TiO₂ | 131.83 | 2.322 |
| 20 | TiO₂ | 27.32 | 0.481 | 20 | SiO₂ | 38.15 | 0.411 |
| 21 | SiO₂ | 40.64 | 0.437 | 21 | TiO₂ | 29.12 | 0.513 |
| 22 | TiO₂ | 131.48 | 2.316 | 22 | SiO₂ | 37.43 | 0.403 |
| 23 | SiO₂ | 40.73 | 0.438 | 23 | TiO₂ | 134.86 | 2.375 |
| 24 | TiO₂ | 26.97 | 0.475 | 24 | SiO₂ | 37.25 | 0.401 |
| 25 | SiO₂ | 41.24 | 0.444 | 25 | TiO₂ | 29.06 | 0.512 |
| 26 | TiO₂ | 128.43 | 2.262 | 26 | SiO₂ | 38.2 | 0.411 |
| 27 | SiO₂ | 41.03 | 0.442 | 27 | TiO₂ | 131.05 | 2.308 |
| 28 | TiO₂ | 25.56 | 0.450 | 28 | SiO₂ | 40.39 | 0.435 |
| 29 | SiO₂ | 40.34 | 0.434 | 29 | TiO₂ | 25.86 | 0.455 |
| 30 | TiO₂ | 121.93 | 2.148 | 30 | SiO₂ | 40.81 | 0.439 |
| 31 | SiO₂ | 39.79 | 0.428 | 31 | TiO₂ | 123.79 | 2.180 |
| 32 | TiO₂ | 23.73 | 0.418 | 32 | SiO₂ | 40.03 | 0.431 |
| 33 | SiO₂ | 41.32 | 0.445 | 33 | TiO₂ | 23.77 | 0.419 |
| 34 | TiO₂ | 120 | 2.114 | 34 | SiO₂ | 40.31 | 0.434 |
| 35 | SiO₂ | 48.51 | 0.522 | 35 | TiO₂ | 119.88 | 2.111 |
| 36 | TiO₂ | 20.92 | 0.368 | 36 | SiO₂ | 44.08 | 0.474 |
| 37 | SiO₂ | 48.47 | 0.522 | 37 | TiO₂ | 22.33 | 0.393 |
| 38 | TiO₂ | 121.79 | 2.145 | 38 | SiO₂ | 43.49 | 0.468 |
| 39 | SiO₂ | 40.44 | 0.435 | 39 | TiO₂ | 121.12 | 2.133 |
| 40 | TiO₂ | 25.44 | 0.448 | 40 | SiO₂ | 35.91 | 0.386 |
| 41 | SiO₂ | 33.5 | 0.360 | 41 | TiO₂ | 25.65 | 0.452 |
| 42 | TiO₂ | 112.88 | 1.988 | 42 | SiO₂ | 30.52 | 0.328 |
| 43 | SiO₂ | 25.53 | 0.275 | 43 | TiO₂ | 114.73 | 2.021 |
| 44 | TiO₂ | 26.49 | 0.467 | 44 | SiO₂ | 32.41 | 0.349 |
| 45 | SiO₂ | 31.53 | 0.339 | 45 | TiO₂ | 24.85 | 0.438 |
| 46 | TiO₂ | 112.4 | 1.980 | 46 | SiO₂ | 37.2 | 0.400 |
| 47 | SiO₂ | 96.48 | 1.038 | 47 | TiO₂ | 111.74 | 1.968 |
| | | | | 48 | SiO₂ | 92.69 | 0.997 |

TABLE 9
Dielectric multilayer film 1C

| | | | |
|---|---|---|---|
| | | Physical film | QWOT at |
| | Film | thickness | wavelength |
| No | material | [nm] | of 550 nm |

Barrier film 1 side

| | | | | |
|---|---|---|---|---|
| 1 | SiO₂ | 36.72 | 0.395 | |
| 2 | TiO₂ | 123.14 | 2.169 | H |
| 3 | SiO₂ | 49.64 | 0.534 | M |
| 4 | TiO₂ | 15.3 | 0.269 | |
| 5 | SiO₂ | 73.45 | 0.790 | L |
| 6 | TiO₂ | 20.75 | 0.365 | M |
| 7 | SiO₂ | 18.7 | 0.201 | |
| 8 | TiO₂ | 103.32 | 1.820 | H |
| 9 | SiO₂ | 36.69 | 0.395 | M |
| 10 | TiO₂ | 12.87 | 0.227 | |
| 11 | SiO₂ | 153.67 | 1.654 | L |
| 12 | TiO₂ | 17.07 | 0.301 | M |
| 13 | SiO₂ | 33.16 | 0.357 | |
| 14 | TiO₂ | 67.85 | 1.195 | H |
| 15 | SiO₂ | 25.78 | 0.277 | M |
| 16 | TiO₂ | 22.91 | 0.404 | |
| 17 | SiO₂ | 113.75 | 1.224 | L |
| 18 | TiO₂ | 14.5 | 0.255 | M |
| 19 | SiO₂ | 34.29 | 0.369 | |
| 20 | TiO₂ | 82.12 | 1.446 | H |
| 21 | SiO₂ | 30.76 | 0.331 | M |
| 22 | TiO₂ | 13.69 | 0.241 | |
| 23 | SiO₂ | 130.11 | 1.400 | L |
| 24 | TiO₂ | 20.76 | 0.366 | M |
| 25 | SiO₂ | 23.28 | 0.251 | |
| 26 | TiO₂ | 75.57 | 1.331 | H |
| 27 | SiO₂ | 32.1 | 0.345 | M |
| 28 | TiO₂ | 16.63 | 0.293 | |
| 29 | SiO₂ | 144.78 | 1.558 | L |
| 30 | TiO₂ | 13.57 | 0.239 | M |
| 31 | SiO₂ | 34.58 | 0.372 | |
| 32 | TiO₂ | 85.31 | 1.503 | H |
| 33 | SiO₂ | 21.85 | 0.235 | M |
| 34 | TiO₂ | 17.87 | 0.315 | |
| 35 | SiO₂ | 125.16 | 1.347 | L |
| 36 | TiO₂ | 15.15 | 0.267 | M |
| 37 | SiO₂ | 28.69 | 0.309 | |
| 38 | TiO₂ | 73.07 | 1.287 | H |
| 39 | SiO₂ | 34.87 | 0.375 | M |
| 40 | TiO₂ | 12.87 | 0.227 | |
| 41 | SiO₂ | 114.91 | 1.237 | L |
| 42 | TiO₂ | 19.14 | 0.337 | M |
| 43 | SiO₂ | 19.35 | 0.208 | |
| 44 | TiO₂ | 75.28 | 1.326 | |
| 45 | SiO₂ | 24.38 | 0.262 | |
| 46 | TiO₂ | 14.33 | 0.252 | |
| 47 | SiO₂ | 169.5 | 1.824 | |
| 48 | TiO₂ | 8.56 | 0.151 | |
| 49 | SiO₂ | 24.65 | 0.265 | |
| 50 | TiO₂ | 20.2 | 0.356 | |
| 51 | SiO₂ | 10.91 | 0.117 | |
| 52 | TiO₂ | 75.31 | 1.326 | H |
| 53 | SiO₂ | 24.98 | 0.269 | M |
| 54 | TiO₂ | 14 | 0.247 | |
| 55 | SiO₂ | 125.31 | 1.348 | L |
| 56 | TiO₂ | 9.95 | 0.175 | M |
| 57 | SiO₂ | 29.22 | 0.314 | |
| 58 | TiO₂ | 68.47 | 1.206 | H |
| 59 | SiO₂ | 17.84 | 0.192 | M |
| 60 | TiO₂ | 19.14 | 0.337 | |
| 61 | SiO₂ | 118.55 | 1.276 | L |
| 62 | TiO₂ | 14.62 | 0.258 | M |
| 63 | SiO₂ | 28.41 | 0.306 | |
| 64 | TiO₂ | 61.82 | 1.089 | |
| 65 | SiO₂ | 25.77 | 0.277 | |
| 66 | TiO₂ | 8.83 | 0.156 | |
| 67 | SiO₂ | 146.88 | 1.581 | |
| 68 | TiO₂ | 106.33 | 1.873 | |
| 69 | SiO₂ | 55.63 | 0.599 | |
| 70 | TiO₂ | 16.02 | 0.282 | |
| 71 | SiO₂ | 36.85 | 0.397 | |
| 72 | TiO₂ | 98.11 | 1.728 | |
| 73 | SiO₂ | 55.7 | 0.599 | |
| 74 | TiO₂ | 12.59 | 0.222 | |
| 75 | SiO₂ | 59.43 | 0.640 | |
| 76 | TiO₂ | 100.26 | 1.766 | |
| 77 | SiO₂ | 54.83 | 0.590 | |
| 78 | TiO₂ | 9.53 | 0.168 | |
| 79 | SiO₂ | 70.02 | 0.753 | |
| 80 | TiO₂ | 110.28 | 1.942 | |
| 81 | SiO₂ | 65.69 | 0.707 | |
| 82 | TiO₂ | 18.56 | 0.327 | |
| 83 | SiO₂ | 38.33 | 0.412 | |
| 84 | TiO₂ | 80.4 | 1.416 | |
| 85 | SiO₂ | 40.18 | 0.432 | |
| 86 | TiO₂ | 18.92 | 0.333 | |
| 87 | SiO₂ | 65.51 | 0.705 | |
| 88 | TiO₂ | 58.75 | 1.035 | |
| 89 | SiO₂ | 9.66 | 0.104 | |
| 90 | TiO₂ | 44.44 | 0.783 | |
| 91 | SiO₂ | 78.73 | 0.847 | |
| 92 | TiO₂ | 17.86 | 0.315 | |
| 93 | SiO₂ | 43.76 | 0.471 | |
| 94 | TiO₂ | 64.37 | 1.134 | |
| 95 | SiO₂ | 35.11 | 0.378 | |
| 96 | TiO₂ | 17.21 | 0.303 | |
| 97 | SiO₂ | 102.93 | 1.108 | |
| 98 | TiO₂ | 26.35 | 0.464 | |
| 99 | SiO₂ | 17.78 | 0.191 | |
| 100 | TiO₂ | 61.61 | 1.085 | |
| 101 | SiO₂ | 91.46 | 0.984 | |

TABLE 10

| Dielectric multilayer film 1D | | | | | | | | Dielectric multilayer film 1E | | | |
|---|---|---|---|---|---|---|---|---|---|---|---|
| | | Physical film | QWOT at | | | Physical film | QWOT at | | | Physical film | QWOT at |
| | Film | thickness | wavelength | | Film | thickness | wavelength | | Film | thickness | wavelength |
| No | material | [nm] | of 550 nm | No | material | [nm] | of 550 nm | No | material | [nm] | of 550 nm |
| Barrier film 1 side | | | | | | | | Barrier film 1 side | | | |
| 1 | TiO₂ | 13.36 | 0.235 | 52 | SiO₂ | 10.09 | 0.109 | 1 | SiO₂ | 32.13 | 0.346 |
| 2 | SiO₂ | 29.88 | 0.322 | 53 | TiO₂ | 68.84 | 1.212 | 2 | TiO₂ | 130.53 | 2.299 |
| 3 | TiO₂ | 228.37 | 4.022 | 54 | SiO₂ | 24.02 | 0.258 | 3 | SiO₂ | 57.64 | 0.620 |
| 4 | SiO₂ | 41.32 | 0.445 | 55 | TiO₂ | 14.66 | 0.258 | 4 | TiO₂ | 13.96 | 0.246 |
| 5 | TiO₂ | 16.41 | 0.289 | 56 | SiO₂ | 117.86 | 1.268 | 5 | SiO₂ | 70.25 | 0.756 |
| 6 | SiO₂ | 81.54 | 0.877 | 57 | TiO₂ | 10.84 | 0.191 | 6 | TiO₂ | 130.73 | 2.303 |
| 7 | TiO₂ | 21.37 | 0.376 | 58 | SiO₂ | 29.78 | 0.320 | 7 | SiO₂ | 66.5 | 0.716 |
| 8 | SiO₂ | 17.37 | 0.187 | 59 | TiO₂ | 67.91 | 1.196 | 8 | TiO₂ | 14.22 | 0.250 |
| 9 | TiO₂ | 102.35 | 1.803 | 60 | SiO₂ | 17.78 | 0.191 | 9 | SiO₂ | 68.19 | 0.734 |
| 10 | SiO₂ | 35.04 | 0.377 | 61 | TiO₂ | 18.58 | 0.327 | 10 | TiO₂ | 131.73 | 2.320 |
| 11 | TiO₂ | 13.39 | 0.236 | 62 | SiO₂ | 118.34 | 1.273 | 11 | SiO₂ | 69.71 | 0.750 |
| 12 | SiO₂ | 153.53 | 1.652 | 63 | TiO₂ | 14.56 | 0.256 | 12 | TiO₂ | 14.4 | 0.254 |
| 13 | TiO₂ | 17.96 | 0.316 | 64 | SiO₂ | 28.41 | 0.306 | 13 | SiO₂ | 66.49 | 0.715 |
| 14 | SiO₂ | 32.61 | 0.351 | 65 | TiO₂ | 58.49 | 1.030 | 14 | TiO₂ | 134.43 | 2.368 |
| 15 | TiO₂ | 68.97 | 1.215 | 66 | SiO₂ | 26.5 | 0.285 | 15 | SiO₂ | 67.49 | 0.726 |
| 16 | SiO₂ | 25.92 | 0.279 | 67 | TiO₂ | 9.44 | 0.166 | 16 | TiO₂ | 14.44 | 0.254 |
| 17 | TiO₂ | 23.06 | 0.406 | 68 | SiO₂ | 141.22 | 1.520 | 17 | SiO₂ | 69.37 | 0.746 |
| 18 | SiO₂ | 121.39 | 1.306 | 69 | TiO₂ | 109.16 | 1.923 | 18 | TiO₂ | 132.77 | 2.338 |
| 19 | TiO₂ | 14.43 | 0.254 | 70 | SiO₂ | 54.98 | 0.592 | 19 | SiO₂ | 66.61 | 0.717 |
| 20 | SiO₂ | 33.88 | 0.365 | 71 | TiO₂ | 16.76 | 0.295 | 20 | TiO₂ | 14.3 | 0.252 |
| 21 | TiO₂ | 79.98 | 1.409 | 72 | SiO₂ | 38.36 | 0.413 | 21 | SiO₂ | 67.73 | 0.729 |
| 22 | SiO₂ | 29.44 | 0.317 | 73 | TiO₂ | 98.93 | 1.742 | 22 | TiO₂ | 128.48 | 2.263 |
| 23 | TiO₂ | 14.7 | 0.259 | 74 | SiO₂ | 54.75 | 0.589 | 23 | SiO₂ | 65.87 | 0.709 |
| 24 | SiO₂ | 129.09 | 1.389 | 75 | TiO₂ | 12.84 | 0.226 | 24 | TiO₂ | 13.68 | 0.241 |
| 25 | TiO₂ | 21.32 | 0.376 | 76 | SiO₂ | 59.12 | 0.636 | 25 | SiO₂ | 62.15 | 0.669 |
| 26 | SiO₂ | 22.92 | 0.247 | 77 | TiO₂ | 102.26 | 1.801 | 26 | TiO₂ | 123.52 | 2.176 |
| 27 | TiO₂ | 74.92 | 1.320 | 78 | SiO₂ | 51.65 | 0.556 | 27 | SiO₂ | 59.95 | 0.645 |
| 28 | SiO₂ | 32.57 | 0.350 | 79 | TiO₂ | 9.45 | 0.166 | 28 | TiO₂ | 13.44 | 0.237 |
| 29 | TiO₂ | 16.74 | 0.295 | 80 | SiO₂ | 73.95 | 0.796 | 29 | SiO₂ | 58.62 | 0.631 |
| 30 | SiO₂ | 144.5 | 1.555 | 81 | TiO₂ | 112.07 | 1.974 | 30 | TiO₂ | 121.11 | 2.133 |
| 31 | TiO₂ | 13.53 | 0.238 | 82 | SiO₂ | 69.43 | 0.747 | 31 | SiO₂ | 58.66 | 0.631 |
| 32 | SiO₂ | 35.48 | 0.382 | 83 | TiO₂ | 19.05 | 0.336 | 32 | TiO₂ | 13.51 | 0.238 |
| 33 | TiO₂ | 80.49 | 1.418 | 84 | SiO₂ | 37.93 | 0.408 | 33 | SiO₂ | 60.37 | 0.650 |
| 34 | SiO₂ | 22.4 | 0.241 | 85 | TiO₂ | 78.18 | 1.377 | 34 | TiO₂ | 120.25 | 2.118 |
| 35 | TiO₂ | 19.79 | 0.349 | 86 | SiO₂ | 40.84 | 0.439 | 35 | SiO₂ | 58.61 | 0.631 |
| 36 | SiO₂ | 109.84 | 1.182 | 87 | TiO₂ | 19.31 | 0.340 | 36 | TiO₂ | 13.82 | 0.243 |
| 37 | TiO₂ | 15.64 | 0.275 | 88 | SiO₂ | 69.27 | 0.745 | 37 | SiO₂ | 57.85 | 0.623 |
| 38 | SiO₂ | 29.39 | 0.316 | 89 | TiO₂ | 59.06 | 1.040 | 38 | TiO₂ | 119.73 | 2.109 |
| 39 | TiO₂ | 77.78 | 1.370 | 90 | SiO₂ | 10.31 | 0.111 | 39 | SiO₂ | 58.18 | 0.626 |
| 40 | SiO₂ | 35.5 | 0.382 | 91 | TiO₂ | 44.17 | 0.778 | 40 | TiO₂ | 13.74 | 0.242 |
| 41 | TiO₂ | 13.22 | 0.233 | 92 | SiO₂ | 81.96 | 0.882 | 41 | SiO₂ | 60.56 | 0.652 |
| 42 | SiO₂ | 105.76 | 1.138 | 93 | TiO₂ | 17.02 | 0.300 | 42 | TiO₂ | 121.05 | 2.132 |
| 43 | TiO₂ | 18.87 | 0.332 | 94 | SiO₂ | 43.99 | 0.473 | 43 | SiO₂ | 61.76 | 0.665 |
| 44 | SiO₂ | 20.48 | 0.220 | 95 | TiO₂ | 65.56 | 1.155 | 44 | TiO₂ | 13.82 | 0.243 |
| 45 | TiO₂ | 76.06 | 1.340 | 96 | SiO₂ | 35.02 | 0.377 | 45 | SiO₂ | 59.28 | 0.638 |
| 46 | SiO₂ | 22.62 | 0.243 | 97 | TiO₂ | 17.21 | 0.303 | 46 | TiO₂ | 103.96 | 1.831 |
| 47 | TiO₂ | 15.11 | 0.266 | 98 | SiO₂ | 102.77 | 1.106 | 47 | SiO₂ | 76.49 | 0.823 |
| 48 | SiO₂ | 163.51 | 1.759 | 99 | TiO₂ | 26.64 | 0.469 | | | | |
| 49 | TiO₂ | 6.72 | 0.118 | 100 | SiO₂ | 16.98 | 0.183 | | | | |
| 50 | SiO₂ | 21.33 | 0.230 | 101 | TiO₂ | 63.11 | 1.112 | | | | |
| 51 | TiO₂ | 21.44 | 0.378 | 102 | SiO₂ | 90.83 | 0.977 | | | | |

TABLE 11

| Dielectric multilayer film 2A | | | | Dielectric multilayer film 2B | | | | Dielectric multilayer film 2C | | | | Dielectric multilayer film 2D | | | |
|---|---|---|---|---|---|---|---|---|---|---|---|---|---|---|---|
| | | Physical | | | | Physical | | | | Physical | | | | Physical | |
| | | film | QWOT at | | | film | QWOT at | | | film | QWOT at | | | film | QWOT at |
| | | thick- | wave- | | | thick- | wave- | | | thick- | wave- | | | thick- | wave- |
| | Film | ness | length | | Film | ness | length | | Film | ness | length | | Film | ness | length |
| No | material | [nm] | of 550 nm | No | material | [nm] | of 550 nm | No | material | [nm] | of 550 nm | No | material | [nm] | of 550 nm |
| Barrier film 2 side | | | | Barrier film 2 side | | | | Barrier film 2 side | | | | Barrier film 2 side | | | |
| 1 | SiO₂ | 53.3 | 0.57 | 1 | SiO₂ | 36.6 | 0.39 | 1 | TiO₂ | 12.0 | 0.22 | 1 | SiO₂ | 25.0 | 0.27 |
| 2 | TiO₂ | 20.7 | 0.37 | 2 | TiO₂ | 35.0 | 0.63 | 2 | SiO₂ | 50.8 | 0.54 | 2 | TiO₂ | 50.0 | 0.90 |
| 3 | SiO₂ | 58.2 | 0.62 | 3 | SiO₂ | 39.0 | 0.42 | 3 | TiO₂ | 20.4 | 0.37 | 3 | SiO₂ | 25.0 | 0.27 |
| 4 | TiO₂ | 10.0 | 0.18 | 4 | TiO₂ | 15.5 | 0.28 | 4 | SiO₂ | 61.7 | 0.66 | 4 | TiO₂ | 17.9 | 0.32 |
| 5 | SiO₂ | 3,000 | 32.01 | 5 | SiO₂ | 3,000 | 32.01 | 5 | TiO₂ | 10.0 | 0.18 | 5 | SiO₂ | 3,000 | 32.01 |
| | | | | | | | | 6 | SiO₂ | 3,000 | 32.01 | | | | |

TABLE 12

| Dielectric multilayer film 2E | | | | Dielectric multilayer film 2F | | | | Dielectric multilayer film 2G | | | | Dielectric multilayer film 2H | | | |
|---|---|---|---|---|---|---|---|---|---|---|---|---|---|---|---|
| | | Physical | | | | Physical | | | | Physical | | | | Physical | |
| | | film | | | | film | | | | film | | | | film | |
| | | thick- | QWOT at | | | thick- | QWOT at | | | thick- | QWOT at | | | thick- | QWOT at |
| | Film | ness | wave- | | Film | ness | wave- | | Film | ness | wave- | | Film | ness | wave- |
| No | material | [nm] | length | No | material | [nm] | length | No | material | [nm] | length | No | material | [nm] | length |
| Barrier film 2 side | | | | Barrier film 2 side | | | | Barrier film 2 side | | | | Barrier film side | | | |
| 1 | SiO₂ | 20.0 | 0.21 | 1 | SiO₂ | 11.0 | 0.12 | 1 | TiO₂ | 13.3 | 0.24 | 1 | SiO₂ | 54.5 | 0.58 |
| 2 | TiO₂ | 74.8 | 1.35 | 2 | TiO₂ | 60.5 | 1.09 | 2 | SiO₂ | 11.0 | 0.12 | 2 | TiO₂ | 21.0 | 0.38 |
| 3 | SiO₂ | 20.0 | 0.21 | 3 | SiO₂ | 11.0 | 0.12 | 3 | TiO₂ | 60.5 | 1.09 | 3 | SiO₂ | 56.1 | 0.60 |
| 4 | TiO₂ | 15.3 | 0.27 | 4 | TiO₂ | 16.2 | 0.29 | 4 | SiO₂ | 11.0 | 0.12 | 4 | TiO₂ | 14.6 | 0.26 |
| 5 | SiO₂ | 3,000 | 32.01 | 5 | SiO₂ | 3,000 | 32.01 | 5 | TiO₂ | 16.2 | 0.29 | 5 | SiO₂ | 23.2 | 0.25 |
| | | | | | | | | 6 | SiO₂ | 3,000 | 32.01 | | | | |

TABLE 13

| Dielectric multilayer film 3A | | | Dielectric multilayer film 3B | | |
|---|---|---|---|---|---|
| | Film | Physical film | | Film | Physical film |
| No | material | thickness [nm] | No | material | thickness [nm] |
| Light-absorbing layer side | | | Light-absorbing layer side | | |
| 1 | TiO₂ | 9.11 | 1 | TiO₂ | 12.46 |
| 2 | SiO₂ | 63.49 | 2 | SiO₂ | 39.96 |
| 3 | TiO₂ | 24.20 | 3 | TiO₂ | 35.19 |
| 4 | SiO₂ | 25.88 | 4 | SiO₂ | 19.80 |
| 5 | TiO₂ | 77.82 | 5 | TiO₂ | 80.21 |
| 6 | SiO₂ | 13.38 | 6 | SiO₂ | 12.82 |
| 7 | TiO₂ | 29.12 | 7 | TiO₂ | 37.40 |
| 8 | SiO₂ | 105.16 | 8 | SiO₂ | 100.21 |

With respect to the respective optical filters obtained as described above, spectral transmittance curves at an incident angle of 0 degrees and an incident angle of 60 degrees, and spectral reflectance curves at an incident angle of 5 degrees and an incident angle of 60 degrees in a wavelength range of 350 nm to 1,200 nm were measured using the ultraviolet-visible spectrophotometer.

Further, for the optical filters of Examples 2-10 and 2-11, the degree of deterioration of the end surface was evaluated by the same method and reference as in the reliability test 1 of glass.

Respective characteristics shown in Tables 14 to 16 below were calculated based on the obtained data of the spectral characteristics.

A method of calculating X in the laminated film 2 will be specifically described by taking the laminated film 2 formed of the dielectric multilayer film 2A and the barrier film 2 as an example. Here, the refractive index of SiO₂ is 1.9 or less, and the refractive index of TiO₂ exceeds 1.9.

A total thickness A (nm) of dielectric layers having a QWOT of less than 2 and a refractive index of 1.9 or less included in the laminated film 2 can be calculated based on a sum of a physical film thickness of a SiO₂ film of film number 1 and a physical film thickness of a SiO₂ film of film number 3 constituting the dielectric multilayer film 2A shown in Table 11.

The entire thickness B (nm) of the laminated film 2 can be calculated based on a sum of a physical film thickness of the entire dielectric multilayer film 2A and a physical film thickness of the barrier film 2.

The total thickness C (nm) of layers having a QWOT of 2 or more in the laminated film 2 corresponds to a physical film thickness of a SiO₂ film of film number 5 constituting the dielectric multilayer film 2A shown in Table 11.

Thus, X was calculated.

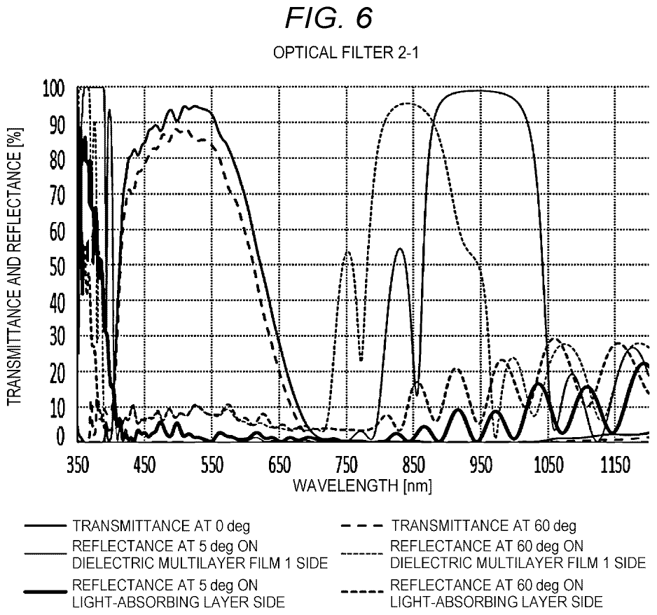

FIG. 6 illustrates spectral transmittance curves and spectral reflectance curves of the optical filter of Example 2-1.

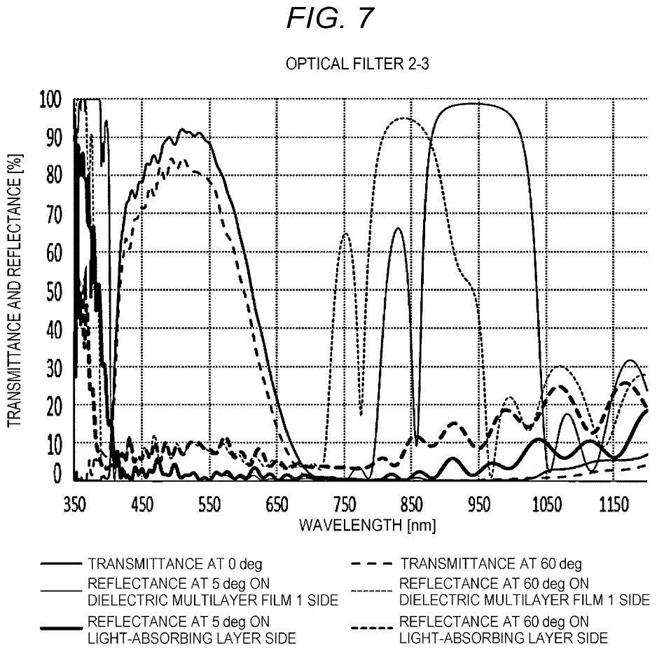

FIG. 7 illustrates spectral transmittance curves and spectral reflectance curves of the optical filter of Example 2-3.

Examples 2-1 to 2-11 are inventive examples.

TABLE 14

| | | | Example 2-1 | Example 2-2 | Example 2-3 | Example 2-4 | Example 2-5 |
|---|---|---|---|---|---|---|---|
| Configuration | Dielectric | Type | 3A | 3A | 3A | 3A | 3A |
| of optical | multilayer | Film configuration | TiO₂/SiO₂ | TiO₂/SiO₂ | TiO₂/SiO₂ | TiO₂/SiO₂ | TiO₂/SiO₂ |
| filter | film 3 | | 8 layers | 8 layers | 8 layers | 8 layers | 8 layers |
| | Light-absorbing | Type | 1 | 1 | 1 | 1 | 1 |
| | layer | | | | | | |
| | Dielectric | Type | 2A | 2B | 2C | 2A | 2C |
| | multilayer | B: entire thickness of | 3,154.1 | 3,141.9 | 3,319.0 | 3,154.1 | 3,319.0 |
| | film 2 | laminated film 2 | | | | | |
| | | (multilayer film 2 + | | | | | |
| | | barrier film 2) [nm] | | | | | |
| | | C: total thickness of | 3,000 | 3,000 | 3,000 | 3,000 | 3,000 |
| | | layers having QWOT of 2 | | | | | |
| | | or more in laminated film | | | | | |
| | | 2 (film thickness of thick | | | | | |
| | | silica film) [nm] | | | | | |
| | | A: total thickness of | 111.4 | 75.5 | 112.5 | 111.4 | 112.5 |
| | | layers having QWOT of | | | | | |
| | | less than 2 and refractive | | | | | |
| | | index of 1.9 or less in the | | | | | |
| | | laminated film 2 [nm] | | | | | |
| | | Film configuration | TiO₂/SiO₂ | TiO₂/SiO₂ | TiO₂/SiO₂ | TiO₂/SiO₂ | TiO₂/SiO₂ |
| | | (excluding thick silica | 4 layers | 4 layers | 5 layers | 4 layers | 5 layers |
| | | film) | | | | | |
| | | X | 72.3% | 53.2% | 72.6% | 72.3% | 72.6% |
| | | X′ | 72.3% | 53.2% | 72.6% | 72.3% | 72.6% |
| | Barrier film 2 | Film material | TiO₂ | TiO₂ | Al₂O₃ | TiO₂ | Al₂O₃ |
| | | Thickness [nm] | 12.93 | 15.89 | 164.11 | 12.00 | 164.11 |
| | Phosphate glass or | Type | Glass 1 | Glass 1 | Glass 2 | Glass 1 | Glass 2 |
| | fluorophosphate | | Phosphate | Phosphate | Fluorophosphate | Phosphate | Fluorophosphate |
| | glass | Thickness [mm] | 0.29 | 0.29 | 0.29 | 0.29 | 0.29 |
| | Barrier film 1 | Film material | TiO₂ | TiO₂ | Al₂O₃ | TiO₂ | Al₂O₃ |
| | | Thickness [nm] | 12.93 | 12.93 | 164.11 | 12.91 | 164.11 |
| | Dielectric | Type | 1A | 1A | 1B | 1C | 1D |
| | multilayer | Total film thicknesses | 2,762.0 | 2,762.0 | 2,915.9 | 5,092.8 | 5,327.6 |
| | film 1 | of multilayer film 1 + | | | | | |
| | | barrier film 1 [nm] | | | | | |
| | | Film configuration | TiO₂/SiO₂ | TiO₂/SiO₂ | TiO₂/SiO₂ | TiO₂/SiO₂ | TiO₂/SiO₂ |
| | | | 47 layers | 47 layers | 48 layers | 101 layers | 102 layers |

| | | | | | | |
|---|---|---|---|---|---|---|
| Spectral | Average transmittance at wavelength of 440 | 88.4 | 88.3 | 84.0 | 88.9 | 84.7 |
| characteristics | nm to 500 nm at 0 deg [%] | | | | | |
| | Average transmittance at wavelength of 440 | 83.0 | 82.9 | 76.9 | 81.4 | 74.3 |
| | nm to 500 nm at 60 deg [%] | | | | | |
| | Wavelength position of IR10 at 0 deg [nm] | 678 | 678 | 671 | 678 | 670 |
| | Wavelength position of IR10 at 60 deg [nm] | 668 | 668 | 659 | 668 | 658 |
| | IR10(0 deg) − IR10(60 deg) [nm] | 10 | 10 | 12 | 10 | 12 |
| | Average transmittance at wavelength of 750 | 0.128 | 0.124 | 0.173 | 0.025 | 0.022 |
| | nm to 1,000 nm at 0 deg [%] | | | | | |
| | Average transmittance at wavelength of 750 | 0.042 | 0.040 | 0.136 | 0.006 | 0.015 |
| | nm to 1,000 nm at 60 deg [%] | | | | | |
| | Transmittance at wavelength of 1,100 nm at 0 | 0.022 | 0.022 | 0.084 | 0.007 | 0.006 |
| | deg [%] | | | | | |
| | Transmittance at wavelength of 1,100 nm at 60 | 0.151 | 0.148 | 0.518 | 0.012 | 0.095 |
| | deg [%] | | | | | |
| | Maximum reflectance at wavelength of 850 nm | 98.94 | 98.94 | 98.83 | 99.84 | 99.88 |
| | to 1,200 nm when incident on multilayer film 1 | | | | | |
| | side at 5 deg [%] | | | | | |
| | Maximum reflectance at wavelength of 450 nm | 10.6 | 12.8 | 11.7 | 14.0 | 19.0 |
| | to 750 nm when incident on light-absorbing | | | | | |
| | layer side at 60 deg [%] | | | | | |
| | Maximum reflectance at wavelength of 750 nm | 29.3 | 35.8 | 25.7 | 29.3 | 25.7 |
| | to 1,200 nm when incident on light-absorbing | | | | | |
| | layer side at 60 deg [%] | | | | | |
| | Maximum reflectance at wavelength of 450 nm | 5.80 | 6.10 | 5.81 | 5.95 | 5.68 |
| | to 750 nm when incident on light-absorbing | | | | | |
| | layer side at 5 deg [%] | | | | | |
| | Average reflectance at wavelength of 800 nm | 65.9 | 65.9 | 65.5 | 99.2 | 99.2 |
| | to 1,100 nm when incident on multilayer film 1 | | | | | |
| | side at 5 deg [%] | | | | | |

TABLE 15

| | | | Example | Example | Example | Example |
|---|---|---|---|---|---|---|
| | | | 2-6 | 2-7 | 2-8 | 2-9 |
| Configuration of | Dielectric multilayer | Type | 3A | 3A | 3A | 3A |
| optical filter | film 3 | Film configuration | TiO₂/SiO₂ | TiO₂/SiO₂ | TiO₂/SiO₂ | TiO₂/SiO₂ |
| | | | 8 layers | 8 layers | 8 layers | 8 layers |
| | Light-absorbing layer | Type | 1 | 1 | 1 | 1 |
| | Dielectric multilayer | Type | 2D | 2E | 2F | 2G |
| | film 2 | B: entire thickness of laminated film 2 | 3,135.4 | 3,145.3 | 3,111.9 | 3,276.0 |
| | | (multilayer film 2 + barrier film 2) [nm] | | | | |
| | | C: total thickness of layers having QWOT of 2 or | 3,000 | 3,000 | 3,000 | 3,000 |
| | | more in laminated film 2 (film thickness of thick | | | | |
| | | silica film) [nm] | | | | |
| | | A: total thickness of layers having QWOT of less | 50.0 | 40.0 | 22.0 | 22.0 |
| | | than 2 and refractive index of 1.9 or less in the | | | | |
| | | laminated film 2 [nm] | | | | |
| | | Film configuration (excluding thick silica film) | TiO₂/SiO₂ | TiO₂/SiO₂ | TiO₂/SiO₂ | TiO₂/SiO₂ |
| | | | 4 layers | 4 layers | 4 layers | 5 layers |
| | | X | 36.9% | 27.5% | 19.6% | 19.6% |
| | | X′ | 36.9% | 27.5% | 19.6% | 19.6% |
| | Barrier film 2 | Film material | TiO₂ | TiO₂ | TiO₂ | Al₂O₃ |
| | | Thickness [nm] | 17.54 | 15.24 | 13.25 | 164.11 |
| | Phosphate glass or | Type | Glass 1 | Glass 1 | Glass 1 | Glass 1 |
| | fluorophosphate glass | | Phosphate | Phosphate | Phosphate | Phosphate |
| | | Thickness [mm] | 0.29 | 0.29 | 0.29 | 0.29 |
| | Barrier film 1 | Film material | TiO₂ | TiO₂ | TiO₂ | Al₂O₃ |
| | | Thickness [nm] | 12.93 | 12.93 | 12.93 | 164.11 |
| | Dielectric multilayer | Type | 1A | 1A | 1A | 1B |
| | film 1 | Total film thicknesses of multilayer | 2,762.0 | 2,762.0 | 2,762.0 | 2,915.9 |
| | | film 1 + barrier film 1 [nm] | | | | |
| | | Film configuration | TiO₂/SiO₂ | TiO₂/SiO₂ | TiO₂/SiO₂ | TiO₂/SiO₂ |
| | | | 47 layers | 47 layers | 47 layers | 48 layers |

| | | | | | |
|---|---|---|---|---|---|
| Spectral | Average transmittance at wavelength of 440 nm to 500 nm at 0 deg [%] | 88.2 | 88.1 | 88.0 | 88.4 |
| characteristics | Average transmittance at wavelength of 440 nm to 500 nm at 60 deg [%] | 82.8 | 82.4 | 82.6 | 82.0 |
| | Wavelength position of IR10 at 0 deg [nm] | 678 | 678 | 677 | 677 |
| | Wavelength position of IR10 at 60 deg [nm] | 667 | 667 | 666 | 666 |
| | IR10(0 deg) − IR10(60 deg) [nm] | 11 | 11 | 11 | 11 |
| | Average transmittance at wavelength of 750 nm to 1,000 nm at 0 deg [%] | 0.119 | 0.117 | 0.111 | 0.105 |
| | Average transmittance at wavelength of 750 nm to 1,000 nm at 60 deg [%] | 0.038 | 0.037 | 0.037 | 0.040 |
| | Transmittance at wavelength of 1,100 nm at 0 deg [%] | 0.022 | 0.022 | 0.022 | 0.030 |
| | Transmittance at wavelength of 1,100 nm at 60 deg [%] | 0.143 | 0.136 | 0.143 | 0.148 |
| | Maximum reflectance at wavelength of 850 nm to 1,200 nm when incident | 98.94 | 98.94 | 98.94 | 98.82 |
| | on multilayer film 1 side at 5 deg [%] | | | | |
| | Maximum reflectance at wavelength of 450 nm to 750 nm when incident | 14.5 | 13.5 | 21.2 | 22.7 |
| | on light-absorbing laver side at 60 deg [%] | | | | |
| | Maximum reflectance at wavelength of 750 nm to 1,200 nm when incident | 40.7 | 43.9 | 44.1 | 39.7 |
| | on light-absorbing layer side at 60 deg [%] | | | | |
| | Maximum reflectance at wavelength of 450 nm to 750 nm when incident | 7.20 | 7.79 | 13.48 | 14.52 |
| | on light-absorbing layer side at 5 deg [%] | | | | |
| | Average reflectance at wavelength of 800 nm to 1,100 nm when incident | 65.9 | 65.9 | 65.9 | 65.5 |
| | on multilayer film 1 side at 5 deg [%] | | | | |

TABLE 16

| | | | Example | Example |
|---|---|---|---|---|
| | | | 2-10 | 2-11 |
| Configuration | Dielectric multilayer | Type | 3B | 3B |
| of optical | film 3 | Film configuration | TiO₂/SiO₂ | TiO₂/SiO₂ |
| filter | | | 8 layers | 8 layers |
| | Light-absorbing layer | Type | 2 | 2 |
| | Dielectric multilayer | Type | 2H | 2H |
| | film 2 | B: entire thickness of laminated film 2 | 181.4 | 181.4 |
| | | (multilayer film 2 + barrier film 2) [nm] | | |
| | | C: total thickness of layers having | 0 | 0 |
| | | QWOT of 2 or more in laminated film 2 | | |
| | | (film thickness of thick silica film) [nm] | | |
| | | A: total thickness of layers having | 111.4 | 111.4 |
| | | QWOT of less than 2 and refractive index | | |
| | | of 1.9 or less in the laminated film 2 [nm] | | |
| | | Film configuration (excluding thick silica film) | TiO₂/SiO₂ | TiO₂/SiO₂ |
| | | | 4 layers | 4 layers |
| | | X | 73.8% | 73.8% |
| | | X′ | 73.8% | 73.8% |
| | Barrier film 2 | Film material | TiO₂ | TiO₂ |
| | | Thickness [nm] | 12.1 | 12.1 |
| | Phosphate glass or | Type | Glass 3 | Glass 4 |
| | fluorophosphate glass | | Phosphate | Phosphate |
| | | Thickness [mm] | 0.3 | 0.25 |
| | Barrier film 1 | Film material | TiO₂ | TiO₂ |
| | | Thickness [nm] | 13.72 | 13.72 |
| | Dielectric multilayer | Type | 1E | 1E |
| | film 1 | Total film thicknesses of multilayer film 1 + barrier | 3,165.8 | 3,165.8 |
| | | film 1 [nm] | | |
| | | Film configuration | TiO₂/SiO₂ | TiO₂/SiO₂ |
| | | | 47 layers | 47 layers |

| Results of reliability test (250 hours) | | A | A |
|---|---|---|---|
| Spectral | Average transmittance at wavelength of 440 nm to 500 nm at 0 deg [%] | 89.67 | 90.19 |
| characteristics | Average transmittance at wavelength of 440 nm to 500 nm at 60 deg [%] | 79.03 | 79.58 |
| | Wavelength position of IR10 at 0 deg [nm] | 669 | 676 |
| | Wavelength position of IR10 at 60 deg \|nm] | 657 | 664 |
| | IR10(0deg) − IR10(60deg) [nm] | 12.0 | 12.0 |
| | Average transmittance at wavelength of 750 nm to 1,000 nm at 0 deg [%] | 0.039 | 0.106 |
| | Average transmittance at wavelength of 750 nm to 1,000 nm at 60 deg [%] | 0.005 | 0.021 |
| | Transmittance at wavelength of 1,100 nm at 0 deg [%] | 0.132 | 0.309 |
| | Transmittance at wavelength of 1,100 nm at 60 deg [%] | 0.133 | 0.373 |
| | Maximum reflectance at wavelength of 850 nm to 1,200 nm when incident on | 99.33 | 99.33 |
| | multilayer film 1 side at 5 deg [%] | | |
| | Maximum reflectance at wavelength of 450 nm to 750 nm when incident on | 15.12 | 15.26 |
| | light-absorbing layer side at 60 deg [%] | | |
| | Maximum reflectance at wavelength of 750 nm to 1,200 nm when incident on | 17.89 | 17.89 |
| | light-absorbing layer side at 60 deg [%] | | |
| | Maximum reflectance at wavelength of 450 nm to 750 nm when incident on | 2.236 | 2.260 |
| | light-absorbing layer side at 5 deg [%] | | |
| | Average reflectance at wavelength of 800 nm to 1,100 nm when incident on | 80.86 | 80.86 |
| | multilayer film 1 side at 5 deg [%] | | |

From the above results, it is understood that the optical filters of Examples 2-1 to 2-11 are excellent in transmittance in the visible light region and shielding properties in the near-infrared region even at a high incident angle.

Further, in the optical filters of Examples 2-1 to 2-6, the reflectance on the light-absorbing layer side is reduced to be low even at a high incident angle. This is because the laminated film 2 (dielectric multilayer film 2+barrier film 2) having X of 35% or more was used.

In addition, it is understood that the optical filters of Examples 2-4 and 2-5 can widely reflect light in the entire near-infrared region of 800 nm to 1,100 nm. This is because the dielectric multilayer film 1C or ID having high light shielding properties in the near-infrared region was used.

From the results of the reliability test of the optical filters of Examples 2-10 and 2-11, the durability could be confirmed even when the entire thickness of the laminated film 2 (multilayer film 2+barrier film 2) was 200 nm or less.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2023-135695) filed on Aug. 23, 2023, the content of which is incorporated herein by reference.

### INDUSTRIAL APPLICABILITY

The optical filter of the present invention is excellent in transmittance of visible light and shielding properties of near-infrared light. In recent years, the optical filter has been useful for applications of information acquisition devices such as cameras and sensors for transport machines, for which high performance has been achieved.

### REFERENCE SIGNS LIST

1A, 1B: optical filter
10: glass
11, 12: barrier film
21, 22, 23: dielectric multilayer film
30: light-absorbing layer

What is claimed is:

1. An optical filter comprising:
a glass;
a dielectric multilayer film 1 and a dielectric multilayer film 2 provided on both surface sides of the glass;
a barrier film 1 provided between the glass and the dielectric multilayer film 1;
a barrier film 2 provided between the glass and the dielectric multilayer film 2; and
a light-absorbing layer provided on or above the dielectric multilayer film 2, wherein
the glass is a phosphate glass having near-infrared ray absorbing properties and being substantially free from fluorine atoms, or a fluorophosphate glass having near-infrared ray absorbing properties and comprising a fluorine atom,
the light-absorbing layer comprises a near-infrared ray absorbing dye having a maximum absorption wavelength at 680 nm to 800 nm,
in a case where the glass is the phosphate glass, the barrier film 1 and the barrier film 2 each independently comprise one or more selected from TiO₂, Nb₂O₅, Ta₂O₅, and HfO₂,
in a case where the glass is the fluorophosphate glass, the barrier film 1 and the barrier film 2 each independently comprise one or more selected from TiO₂, Al₂O₃, Nb₂O₅, Ta₂O₅, and HfO₂, and
the optical filter satisfies all of the following spectral characteristics (i-1) to (i-3) and (i-6):
(i-1) an average transmittance at a wavelength of 440 nm to 500 nm is 80% or more at an incident angle of 0 degrees and 70% or more at an incident angle of 60 degrees,
(i-2) an average transmittance at a wavelength of 750 nm to 1,000 nm is 1% or less at an incident angle of 0 degrees and 1% or less at an incident angle of 60 degrees,
(i-3) in a spectral transmittance curve at an incident angle of 0 degrees, a wavelength IR10_{(0deg)} at which a transmittance is 10% is in a range of 600 nm to 700 nm, and
(i-6) when a light is incident from a dielectric multilayer film 1 side, a maximum reflectance at a wavelength of 850 nm to 1,200 nm is 85% or more at an incident angle of 5 degrees.

2. The optical filter according to claim 1, wherein
the optical filter satisfies the following spectral characteristics (i-4) and (i-5):
(i-4) an absolute value of a difference between the wavelength IR10_{(0deg)} at which the transmittance is 10% in the range of 600 nm to 700 nm in the spectral transmittance curve at an incident angle of 0 degrees and a wavelength IR10_{(60deg)} at which a transmittance is 10% in the range of 600 nm to 700 nm in a spectral transmittance curve at an incident angle of 60 degrees is 20 nm or less, and
(i-5) a transmittance at a wavelength of 1,100 nm is 1% or less at an incident angle of 0 degrees and 3% or less at an incident angle of 60 degrees.

3. The optical filter according to claim 1, wherein
the optical filter satisfies the following spectral characteristics (i-7) and (i-8):
(i-7) when a light is incident from a light-absorbing layer side, a maximum reflectance at a wavelength of 450 nm to 750 nm is 20% or less at an incident angle of 60 degrees, and
(i-8) when a light is incident from the light-absorbing layer side, a maximum reflectance at a wavelength of 750 nm to 1,200 nm is 42% or less at an incident angle of 60 degrees.

4. The optical filter according to claim 1, wherein
when a film comprising the barrier film 2 and the dielectric multilayer film 2 is defined as a laminated film 2,
X represented by the following formula (1): X (%)={_{A}/(B−C)}×100 is 35% or more,
in which, when each layer included in the laminated film 2 is evaluated based on a QWOT represented by the following formula (2): QWOT=(thickness of target layer (nm)/550 (nm))×4×(refractive index at wavelength of 550 nm of target layer),
A (nm) is a total thickness of layers having a QWOT of less than 2 and a refractive index of 1.9 or less in the laminated film 2,
B (nm) is an entire thickness of the laminated film 2, and
C (nm) is a total thickness of layers having a QWOT of 2 or more in the laminated film 2.

5. The optical filter according to claim 1, wherein
the optical filter satisfies the following spectral characteristic (i-9):
(i-9) when a light is incident from a light-absorbing layer side, a maximum reflectance at a wavelength of 450 nm to 750 nm is 7.5% or less at an incident angle of 5 degrees.

6. The optical filter according to claim 1, wherein
the optical filter satisfies the following spectral characteristic (i-10):
(i-10) when a light is incident from the dielectric multilayer film 1 side, an average reflectance at a wavelength of 800 nm to 1,100 nm is 95% or more at an incident angle of 5 degrees.

7. The optical filter according to claim 1, wherein
the phosphate glass is substantially free from fluorine atoms, and
the phosphate glass comprises, in terms of mol % based on oxides,
40% to 75% of P₂O₅,
10% to 30% of Al₂O₃,
0.1% to 30% of ΣR₂₀ where R₂O is one or more components selected from Li₂O, Na₂O, K₂O, Rb₂O, and Cs₂O, and ΣR₂₀ is a total content of R₂O,
0% to 30% of ΣR′O where R′O is one or more components selected from CaO, MgO, BaO, SrO, and ZnO, and ΣR′O is a total content of R′O, and
2% to 30% of CuO.

8. The optical filter according to claim 1, wherein
the fluorophosphate glass comprises, in terms of mass %,
20% to 70% of P⁵⁺
1% to 20% of Al³⁺,
0% to 30% of Li⁺,
0% to 40% of Na⁺,
0% to 40% of K⁺,
0% to 20% of Rb⁺,
0% to 20% of Cs⁺,
0% to 20% of Mg²⁺,
0% to 20% of Ca²⁺,
0% to 30% of Sr²⁺,
0% to 40% of Ba²⁺,
1% to 55% of ΣR⁺ where R⁺ is one or more components selected from Li⁺, Na⁺, K⁺, Rb⁺, and Cs⁺,
1% to 50% of ΣR²⁺ where R²⁺ is one or more components selected from Mg²⁺, Ca²⁺, Sr²⁺, and Ba²⁺,
1% to 20% of Cu²⁺, and
0% to 20% of Zn²⁺, and
the fluorophosphate glass comprises, in terms of outer percentage, 3 mass % to 60 mass % of F⁻when a content of a component element other than F⁻included in the glass is set to 100 mass %.

9. The optical filter according to claim 1, wherein
the glass has, in terms of a plate thickness of 0.2 mm,
a transmittance of 80% or more at a wavelength of 420 nm,
a transmittance of 6% or less at a wavelength of 800 nm, and
a transmittance of 25% or less at a wavelength of 1,200 nm.

10. The optical filter according to claim 1, wherein
the dielectric multilayer film 1 satisfies the following characteristic (iiA-1):
(iiA-1) the dielectric multilayer film 1 comprises a repeating laminated structure represented by (high refractive index layer H_{A}/medium refractive index layer M_{A}/low refractive index layer L_{A}/medium refractive index layer M_{A})ₙ where
n represents a natural number of 2 or more,
the high refractive index layer H_{A} comprises a high refractive index material having a refractive index of 1.8 or more and 3.0 or less at a wavelength of 500 nm,
the medium refractive index layer M_{A} comprises a medium refractive index material having a refractive index relatively lower than that of the high refractive index material and having a refractive index of 1.5 or more and 2.0 or less at a wavelength of 500 nm,
the low refractive index layer LA comprises a low refractive index material having a refractive index relatively lower than that of the medium refractive index material and having a refractive index of 1.3 or more and 1.7 or less at a wavelength of 500 nm, and
in a case where the medium refractive index layer M_{A} comprises the high refractive index layer H_{A} and the low refractive index layer L_{A}, the medium refractive index layer M_{A} is treated as an equivalent film.

11. The optical filter according to claim 1, wherein
in the case where the glass is the phosphate glass, the barrier film 1 and the barrier film 2 comprise TiO₂, and
in the case where the glass is the fluorophosphate glass, the barrier film 1 and the barrier film 2 each independently comprise at least one of TiO₂ and Al₂O₃.

12. The optical filter according to claim 1, wherein
the light-absorbing layer comprises:
one or more near-infrared ray absorbing dyes having a maximum absorption wavelength in a range of 700 nm or more and less than 740 nm; and
one or more near-infrared ray absorbing dyes having a maximum absorption wavelength in a range of 740 nm or more and 800 nm or less.

13. An imaging device comprising the optical filter according to claim 1.
